(19) United States
(12) Patent Application Publication
(10) Pub. No.: US 2016/0186715 A1
(43) Pub. Date: Jun. 30, 2016

(54) BUOY FOR OBTAINING ENERGY FROM A WAVE IN A BODY OF WATER

(71) Applicant: Mitchell Fait, Colorado Springs, CO (US)

(72) Inventor: Mitchell Fait, Colorado Springs, CO (US)

(21) Appl. No.: 14/918,377

(22) Filed: Oct. 20, 2015

Related U.S. Application Data
(63) Continuation of application No. PCT/US2015/012001, filed on Jan. 20, 2015.
Application No. PCT/US2015/012001 is a continuation of application No. PCT/US2015/027852, filed on Apr. 27, 2015.
(60) Provisional application No. 62/065,928, filed on Oct. 20, 2014.
(60) Provisional application No. 61/929,309, filed on Jan. 20, 2014.
(60) Provisional application No. 62/007,822, filed on Jun. 4, 2014.

(51) Int. Cl. F03B 13/18

(52) U.S. Cl. CPC F03B 13/1845; F03B 13/1815

(57) ABSTRACT

A buoy for obtaining energy from a wave in a body of water, and associated methods are disclosed. The buoy can include a floatation portion to provide buoyancy for the buoy in water. The buoy can also include a ballast portion operable with the floatation portion to move in a pendulum motion in response to a wave in the body of water. The floatation portion can be substantially maintained above the ballast portion. In addition, the buoy can include an energy conversion device to generate power in response to the pendulum motion of the ballast portion.

The present application claims the benefit of U.S. Provisional Patent Application No. 62/065,928, filed on Oct. 20, 2014; and also claims priority to and the benefit of PCT Patent Application No. PCT/US2015/012001 filed on Jan. 20, 2015, which claims the benefit of U.S. Provisional Patent Application No. 61/929,309 filed on Jan. 20, 2014; and also claims priority to and the benefit of PCT Patent Application No. PCT/US2015/027852 filed on Apr. 27, 2015, which claims the benefit of U.S. Provisional Patent Application No. 62/007,822 filed on Jun. 4, 2014; each of which is incorporated herein by reference.

### BACKGROUND

The ocean has great potential for generating usable energy if it can be harnessed efficiently. For example, ocean waves, high and low ocean tides, and/or temperature differences in the water are a several ways that the ocean can be used to generate useable energy. Ocean waves, in particular, can have a significant amount of kinetic energy and this energy can be used to power various systems. Although there are many systems for generating energy from the movement of ocean water, there is a continued need for improvements in the way wave energy is harnessed. For example, many devices have free floating buoys to harness usable energy from ocean waves. For these devices to continue functioning, the buoys should have stability to re-center themselves after a wave passes. However, many devices are unstable, thus tilting to one side and remaining there, no longer generating electricity.

### BRIEF DESCRIPTION OF DRAWINGS

FIG. 1 illustrates an array of buoys for obtaining energy from a wave in a body of water, in accordance with an embodiment of the present disclosure.

FIG. 2 illustrates an array of buoys for obtaining energy from a wave in a body of water, in accordance with another embodiment of the present disclosure.

FIGS. 3A-3C illustrate an array of buoys in operation with waves of a typical or design size, in accordance with an embodiment of the present disclosure.

FIGS. 4A-4C illustrate an array of buoys in operation with waves that exceed a typical or design wave size, such as a rogue wave, in accordance with an embodiment of the present disclosure.

FIGS. 5A and 5B are illustrations of a buoy for obtaining energy from a wave in a body of water, in accordance with an example of the present disclosure.

FIG. 6 is an illustration of a buoy for obtaining energy from a wave in a body of water, in accordance with another example of the present disclosure.

FIGS. 7A and 7B are illustrations of a buoy for obtaining energy from a wave in a body of water, in accordance with yet another example of the present disclosure.

FIG. 8 is an illustration of a buoy for obtaining energy from a wave in a body of water, in accordance with still another example of the present disclosure.

FIG. 9 illustrates an energy conversion device of a buoy for obtaining energy from a wave in a body of water, in accordance with an example of the present disclosure.

FIG. 10 illustrates an energy conversion device of a buoy for obtaining energy from a wave in a body of water, in accordance with another example of the present disclosure.

FIG. 11 illustrates an energy conversion device in accordance with another example of the present disclosure.

FIG. 12 illustrates a buoy for obtaining energy from a wave in a body of water, in accordance with another example of the present disclosure.

FIGS. 13A-13E illustrate magnetic bearing arrangements in according with several examples of the present disclosure.

FIGS. 14A and 14B illustrate an energy conversion device in accordance with another example of the present disclosure.

FIG. 15 illustrates an energy conversion device in accordance with another example of the present disclosure.

FIGS. 16A and 16B illustrate flexible support member routing configurations within energy conversion devices in accordance with examples of the present disclosure.

FIG. 17 illustrates an energy conversion device in accordance with another example of the present disclosure.

FIG. 18A illustrates an energy conversion device in accordance with another example of the present disclosure.

FIG. 18B illustrates a permanent magnet configuration of the energy conversion device of FIG. 18A, in accordance with an example of the present disclosure.

FIG. 19A illustrates an energy conversion device in accordance with another example of the present disclosure.

FIG. 19B illustrates a permanent magnet configuration of the energy conversion device of FIG. 19A, in accordance with an example of the present disclosure.

FIGS. 20A-20C illustrate energy conversion devices in accordance with several examples of the present disclosure.

FIGS. 21A and 21B illustrate a cross configuration for maintaining stability of an array of buoys in the water, in accordance with an embodiment of the present disclosure.

FIGS. 22A and 22B illustrate a configuration for maintaining stability of an array of buoys in the water as well as for extending the array to include any number of movable buoys and/or base buoys, in accordance with an embodiment of the present disclosure.

FIG. 23 illustrates a system for obtaining energy from surface waves, in accordance with an embodiment of the present disclosure.

FIG. 24 illustrates a system for obtaining energy from surface waves, in accordance with another embodiment of the present disclosure.

FIG. 25A illustrates a system for obtaining energy from surface waves, in accordance with yet another embodiment of the present disclosure.

FIG. 25B illustrates the system of FIG. 25A when subjected to an extreme wave.

FIGS. 26A and 26B illustrate the system of FIG. 25A aligning with varying wind/wave directions.

FIG. 27A illustrates a system for obtaining energy from surface waves, in accordance with still another embodiment of the present disclosure.

FIG. 27B illustrates the system of FIG. 27A when at high tide.

FIG. 27C illustrates the system of FIG. 27A when subjected to an extreme wave.

FIG. 28 illustrates a system for obtaining energy from surface waves, in accordance with still another embodiment of the present disclosure.

FIGS. 29A and 29B illustrate a system for obtaining energy from surface waves in accordance with a further example of the present disclosure.

FIG. 30 illustrates a system for obtaining energy from surface waves, in accordance with another embodiment of the present disclosure.

FIG. 31 illustrates a system for obtaining energy from surface waves, in accordance with yet another embodiment of the present disclosure.

FIG. 32 illustrates a top cross-sectional view of the system of FIG. 31.

FIG. 33A is an illustration of an underwater utility line in accordance with an example of the present disclosure.

FIG. 33B is the underwater utility line of FIG. 33A in an expanded configuration accordance with an example of the present disclosure.

FIG. 33C is the underwater utility line of FIG. 33A in a contracted configuration.

FIG. 34 is an illustration of an underwater utility line in accordance with another example of the present disclosure.

FIG. 35 is an illustration of an underwater utility line in accordance with yet another example of the present disclosure.

FIG. 36 is an illustration of an underwater utility line in accordance with still another example of the present disclosure.

FIG. 37 is an illustration of an underwater utility line in accordance with a further example of the present disclosure.

FIG. 38 is an illustration of an underwater utility system in accordance with an example of the present disclosure.

FIG. 39 is an illustration of an underwater utility system in accordance with another example of the present disclosure.

FIG. 40 is an illustration of an underwater utility system in accordance with yet another example of the present disclosure.

FIG. 41 is an illustration of an underwater utility system in accordance with still another example of the present disclosure.

FIG. 42A is an illustration of an underwater utility system in accordance with a further example of the present disclosure.

FIG. 42B is an illustration of an underwater utility system in accordance with an additional example of the present disclosure.

FIG. 43 is a side view of a tether or feed line of an underwater utility system in accordance with an example of the present disclosure.

FIG. 44 is a top view of a tether or feed line of an underwater utility system in accordance with another example of the present disclosure.

### DETAILED DESCRIPTION

Reference will now be made to the exemplary embodiments, and specific language will be used herein to describe the same. It will nevertheless be understood that no limitation of the scope of the disclosure is thereby intended. Alterations and further modifications of the inventive features illustrated herein, and additional applications of the principles of the technology as illustrated herein, which would occur to one skilled in the relevant art and having possession of this disclosure, are to be considered within the scope of the disclosure. It is also to be understood that the terminology used herein is used for the purpose of describing particular embodiments only. The terms are not intended to be limiting unless specified as such.

It should be noted that, as used in this specification and the appended claims, the singular forms “a,” “an,” and “the” include plural referents unless the content clearly dictates otherwise.

In describing embodiments of the present disclosure, reference will be made to “first” or “second” as they relate to spacer threaded portions, for example. It is noted that these are merely relative terms, and a spacer threaded portion described or shown as a “first” threaded portion could just as easily be referred to a “second” threaded portion, and such description is implicitly included herein.

Dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight ratio range of about 1 wt % to about 20 wt % should be interpreted to include not only the explicitly recited limits of about 1 wt % and about 20 wt %, but also to include individual weights such as 2 wt %, 11 wt %, 14 wt %, and sub-ranges such as 10 wt % to 20 wt %, 5 wt % to 15 wt %, etc.

In accordance with these definitions and embodiments of the present disclosure, a discussion of the various systems and methods is provided including details associated therewith. This being said, it should be noted that various embodiments will be discussed as they relate to the systems and methods. Regardless of the context of the specific details as they are discussed for any one of these embodiments, it is understood that such discussion relates to all other embodiments as well.

The present disclosure is drawn to buoy for obtaining energy from a wave in a body of water. The buoy can include a floatation portion to provide buoyancy for the buoy in water. The buoy can also include a ballast portion operable with the floatation portion to move in a pendulum motion in response to a wave in the body of water. The floatation portion can be substantially maintained above the ballast portion. In addition, the buoy can include an energy conversion device to generate power in response to the pendulum motion of the ballast portion.

In another aspect, the disclosure provides a method for obtaining energy from a wave in a body of water. The method can comprise obtaining a buoy having a floatation portion to provide buoyancy for the buoy in water, a ballast portion operable with the floatation portion to move in a pendulum motion in response to a wave in the body of water, wherein the floatation portion is substantially maintained above the ballast portion, and an energy conversion device to generate power in response to the pendulum motion of the ballast portion. Additionally, the method can comprise disposing the buoy in the body of water.

In another aspect, the disclosure provides a buoy for obtaining energy from a wave in a body of water that can comprise first and second floatation portions to provide buoyancy in water, and an energy conversion device associated with the first and second floatation portions. The energy conversion device can include a frame defining a first side and a second side. The energy conversion device can also include a permanent magnet supported by the frame. In addition, the energy conversion device can include a first stator assembly disposed about the first side of the frame and coupled to the first floatation portion, and a second stator assembly disposed about the second side of the frame and coupled to the second floatation portion. The first and second floatation portions can be moveable relative to the frame such that a wave in a body of water causes relative movement of the first and second stator assemblies and the permanent magnet to generate electricity via electromagnetic induction.

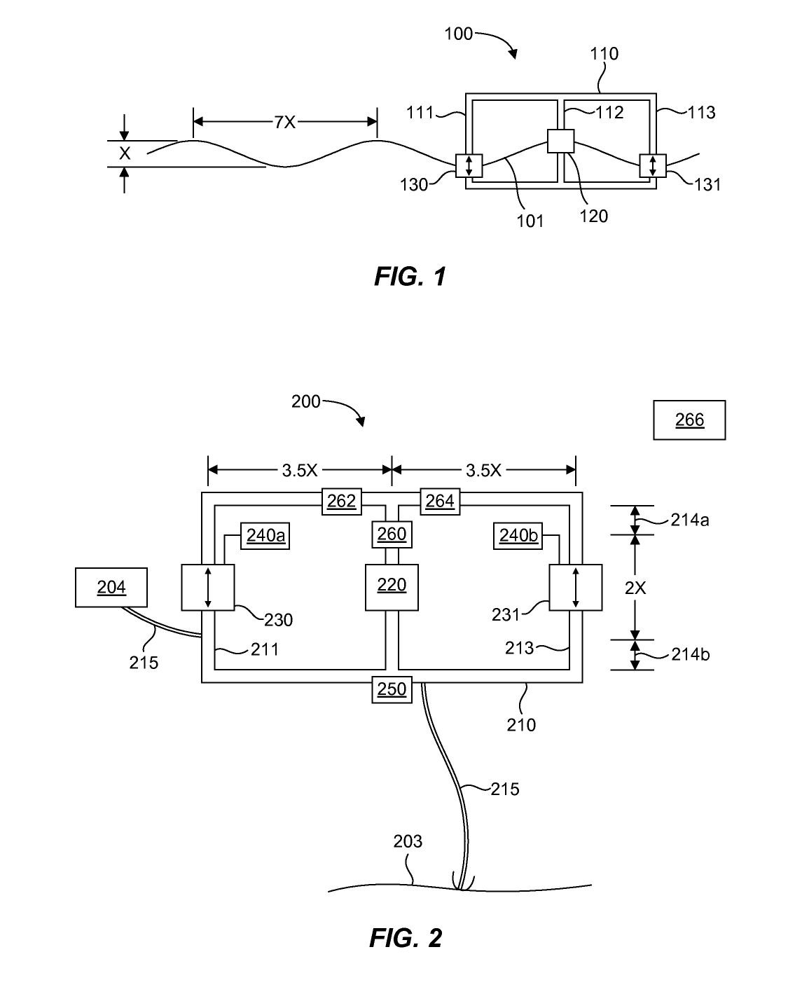

FIG. 1 shows an array of buoys 100 for obtaining energy from a wave 101 in a body of water. The array of buoys can include a framework 110 having a plurality of vertical members 111, 112, 113. The array of buoys can also include a base buoy 120 coupled to the framework to support the framework in the body of water and maintain the vertical members in a vertical orientation. In one aspect, the base buoy can be fixedly attached to the framework at or near a center of the framework, such as to a middle or primary column, to effectively support the framework in the water. The array of buoys can also include a plurality of movable buoys 130, 131, such that each of the plurality of movable buoys is movably disposed about a different one of the plurality of vertical members, such as an outer column, and configured to move relative to the respective vertical members and the base buoy in response to a wave in the body of water. In one aspect, the movable buoys can be configured to freely move or slide up and down relative to the vertical members and the base buoy. An energy conversion device can also be included and can be operable with each of the plurality of movable buoys to generate power from movement of the movable buoys relative to the vertical members.

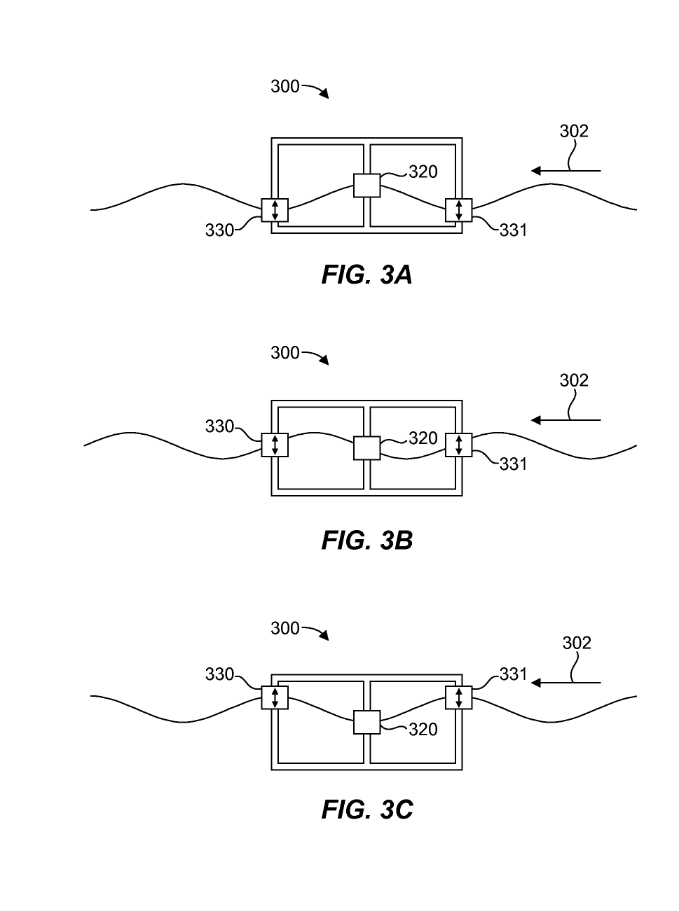

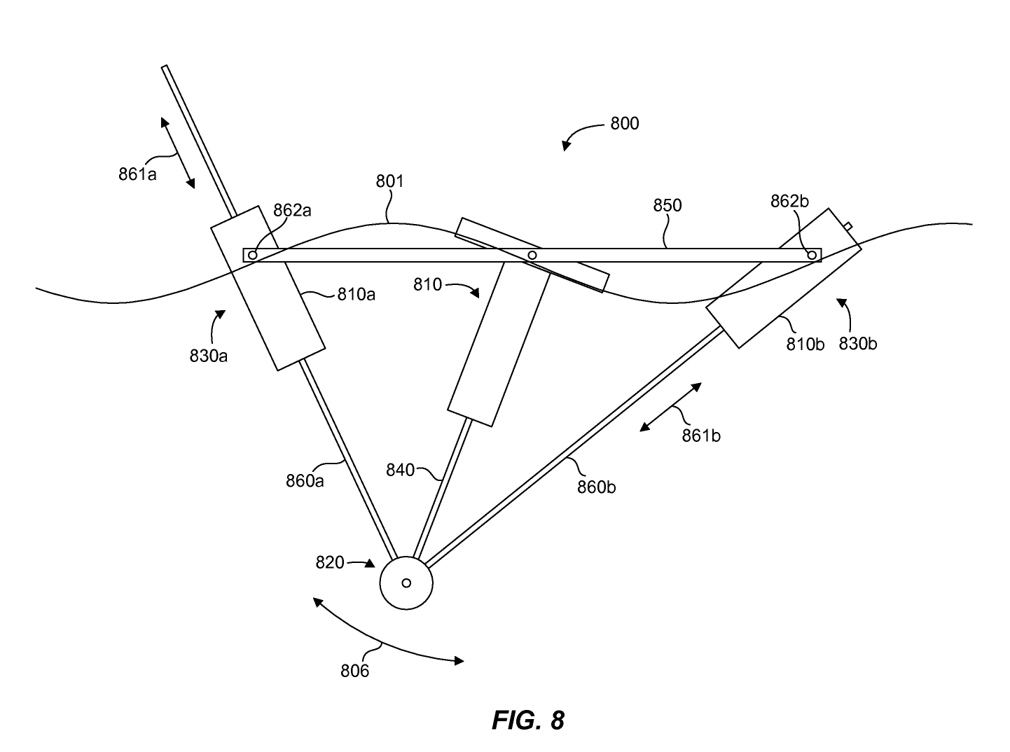

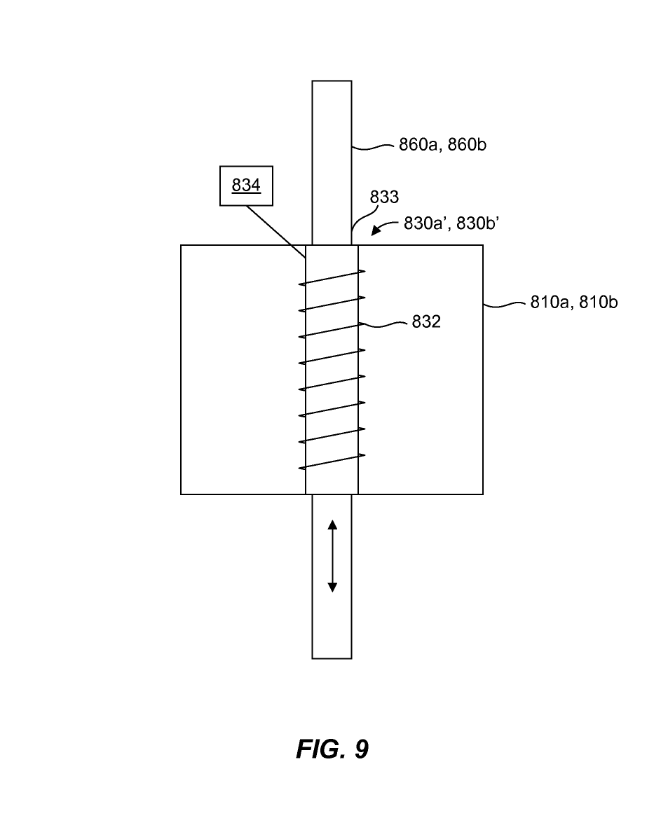

It is noted that the embodiment shown in FIG. 1 as well as in FIGS. 2-4c hereinafter may or may not be inherently stable in the ocean, as additional stabilizing structures would typically be included to maintain the vertical members in a generally vertical configuration. These devices are shown in this manner without one or more of the many possible stabilizing structures that could be used in order to more clearly illustrate how the device functions at a basic level. Certain devices that may be more stable in the waves of the ocean are shown by example in FIGS. 7A-8B, and there are many other stable configurations that could likewise be devised that utilize the basic structure shown in FIGS. 1-4c. Furthermore, it is noted that the term “vertical” is defined as being generally vertical with respect to the construction of the framework as the device sits in the water. As waves pass by the device, the “vertical” members will not remain completely vertical at all times, but as mentioned, will be generally vertical in orientation.

With reference to FIG. 2, and continued reference to FIG. 1, an array of buoys 200 for obtaining energy from a wave in a body of water can be configured based on relationships to typical (design) wave expected to be encountered by the array of buoys. For example, it has been observed that typical deep water waves have a reasonably constant wave height and a wavelength relationship. Specifically, for a given wave height (X), the wave length for waves with the largest stable slope is about seven times (7×) the wave height from peak to trough. Waves with extreme slopes greater than this relationship typically break and collapse. The frame may tip to ride these extreme waves which have steeper slopes. In one aspect, the array of buoys can be designed for a specific wave height where the range of motion of the movable buoys relative to the vertical members is about two times (2×) the wave height. The base buoy can be configured to support the framework in the water to facilitate movement of the movable buoys up to two times the design wave height. In addition, the distance between the base buoy and a movable buoys can be from about two times the wave height (2× or 2:1 ratio) to about five times the wave height (5× or 5:1 ratio). In one particular aspect, the distance between the base buoy and a movable buoys is about three-and-a-half times the design wave (3.5× or 3.5:1 ratio). In this configuration, the base buoy can support the framework in the water such that the vertical floating movement of the movable buoys relative to the vertical members of the framework can move up to the distance of the lesser of two times the wave height or two times the slope times the fixed horizontal distance for the frame of floating buoys.

The array of buoys can be used to obtain energy from water waves to produce energy through pumping water, pumping air, induction, or conversion through any other type of mechanical motion since each movable buoy can have attached to it an energy conversion device known in the art for converting mechanical motion into energy, such as a pump or electrical generator. It should be recognized that although the array of buoys can be designed for deep ocean water waves, other waves can alternatively be utilized.

In addition, each vertical member 211, 213 can have a height of two times (2×) the design wave height plus lengths 214a, 214b to accommodate variables such as the movable buoy height as well as a safety distance to provide additional clearance to minimize the chance of impact due to the fact that it is unlikely that each movable buoy will always float with the water exactly in the middle of the buoy height. Energy conversion devices 240a, 240b can be operable with the movable buoys 230, 231 to generate power from movement of the movable buoys relative to the vertical members.

A tether 215 can be coupled to the framework 210 to anchor the array of buoys 200 to an object, such as an ocean floor 203 or to an object 204 floating on a surface of the body of water such as a boat or oil rig. The tether can be configured to allow the array of buoys to move effectively in the water on the waves without permitting the array of buoys to stray too far from a desired location.

In one aspect, the array of buoys 200 can include a locomotion device 250 operable to move the array of buoys through the body of water. The locomotion device can be used to move the array of buoys to a desired location and/or to maintain the array of buoys at a desired position. For example, the locomotion device can be used to move the array of buoys from a deployment location, such as a dock, to a deep water location for harvesting energy. In one aspect, locomotion device can be also used to provide movement for a ship or other water vessel by coupling the array of buoys to the ship.

The array of buoys 200 can also include various systems useful for operating the array of buoys, such as a control system 260 operable to control operation of the array of buoys, a communication system 262 operable to communicate with a command center or base station, and/or a global positioning system (GPS) 264. For example, the control system can monitor various aspects of the array of buoys, such as the amount of energy generated. The communication system can communicate with a base 266, such as a command center located on land or on a ship. The GPS can monitor location of the array of buoys. Thus, the command center can receive data from the array of buoys as well as give operating instructions, such as a location to move to, etc. In response to such instructions, the locomotion device 250 can move the array of buoys to a location using the GPS for navigation.

The array of buoys 200 can be constructed of any suitable material. For example, typical structural materials suitable for marine use may be used, particularly those suitable for salt water applications when contemplating use in the ocean. In addition, the array of buoys can use hydrophobic materials on its surfaces so that any ice that forms during cold weather will shear and fall off the buoys and the framework as the array of buoys moves in the ocean, thereby preventing ice buildup.

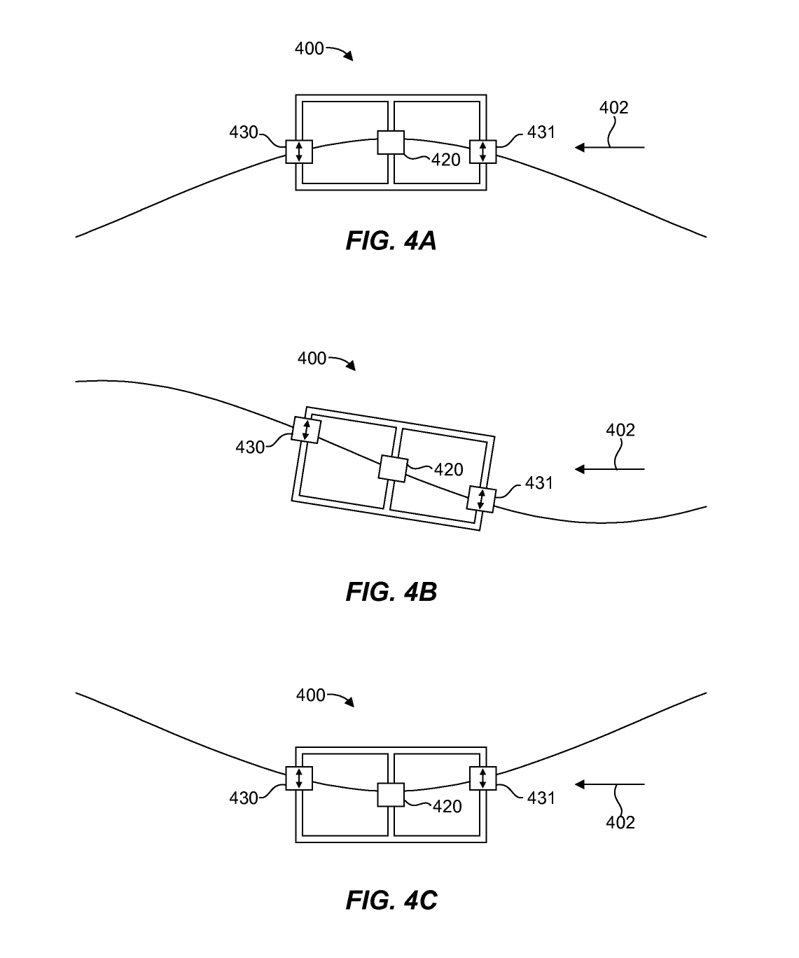

FIGS. 3A-3C illustrate an array of buoys 300 in operation with waves of a typical or design size. For example, as shown in FIG. 3A, the two movable buoys 330, 331 on opposite sides of the base buoy 320, at a distance from the base buoy as outlined above, are able to be at the lowest points, or troughs of a wave, while the base buoy 320 is at a highest point, or a crest of the wave. FIG. 3B shows the wave moving in direction 302 and causing the base buoy to fall off the crest while the movable buoys ride up out of the troughs toward crests. When the wave moves a distance of three-and-a-half wave heights, as shown in FIG. 3C, the movable buoys have switched vertical positions so that the movable buoys are at crests of a wave and the base buoy is at a trough. This creates a total vertical movement for each movable buoy along the vertical member associated with the movable buoy of the lesser of two times the wave height or two times the slope times the fixed horizontal distance for the frame of floating buoys.

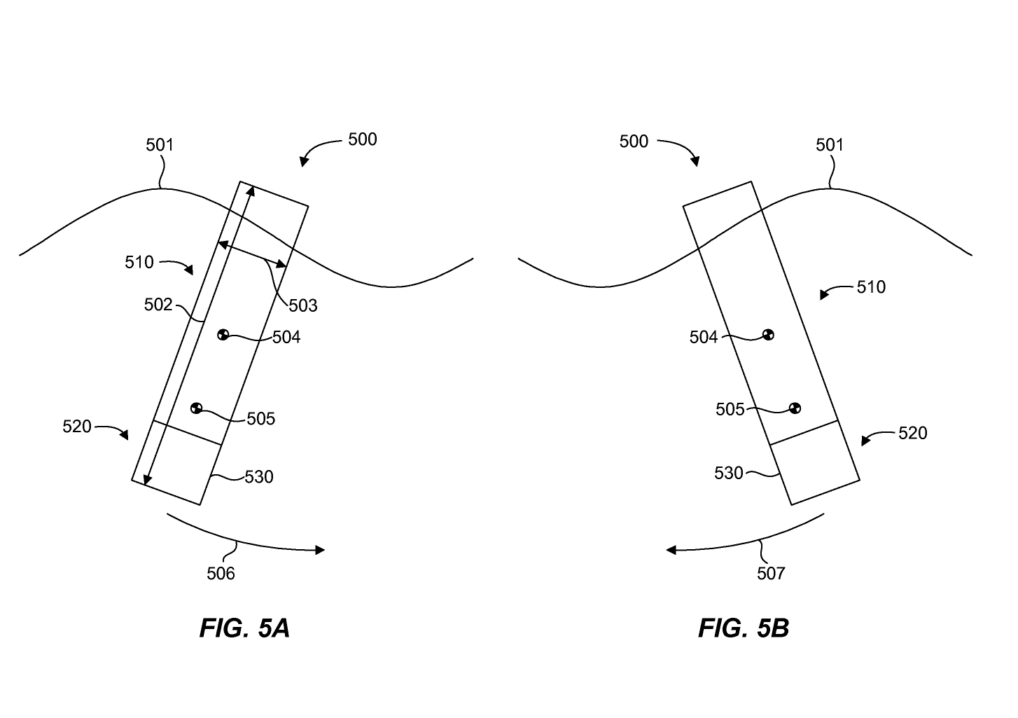

FIGS. 4A-4C illustrate an array of buoys 400 in operation with waves that exceed a typical or design wave size, such as a rogue wave. For example, as shown in FIG. 4A, the base buoy 420 lifts the entire array of buoys up on the crest of the wave, with the two movable buoys 430, 431 on opposite sides of the base buoy 420 on either side of the crest of the wave. FIG. 4B shows the wave moving in direction 402 and causing the array of buoys to fall off the crest of the wave. The movable buoys float on the wave such that movable buoy 430 tends to rise relative to the vertical member of the framework while movable buoy 431 tends to fall relative to the vertical member of the framework. In the event that the framework becomes unstable, the framework may tip causing the movable buoy to rise up the vertical member until it has reached the end of the range of motion, at which point it will prevent further tipping of the framework. Thus, the array of buoys can effectively ride up or down a large wave without tipping over. As shown in FIG. 4C, upon the base buoy reaching the trough of the wave, the movable buoys have moved up relative to the vertical members. The array of buoys can operate in any size wave by riding the slope of the wave and can therefore keep operating through hurricanes and tsunamis without damage. No matter how high the waves get, the buoys can keep floating and move without collision or damaging movement. No braking method or stop motion is required for extremely large ocean waves.

The array of buoys can produce the same amount of energy whenever the ocean waves are higher than or equal to the designed wavelength for the array. This permits a system to be designed for a specific capacity without wide fluctuations in performance as long as the actual wave height is greater than or equal to the wave height for which the array 1 has been designed. Such attributes are attractive for using an array of buoys as primary power, replacing nuclear, petroleum, natural gas, or coal plants. There is no need to vary the size of the framework to accommodate ocean depth differences which impact other ocean wave devices which are attached to the ocean floor. Every device can be the same, thereby creating cost savings and improving manufacturability. In addition, because the entire array of buoys floats, operation in deep ocean waves is enabled. This allows placement of the device far from land so that deep ocean waves, which are larger than those close to shore, can be harvested for energy, and avoids cluttering the coastal waterways or taking up real estate used for tourism.

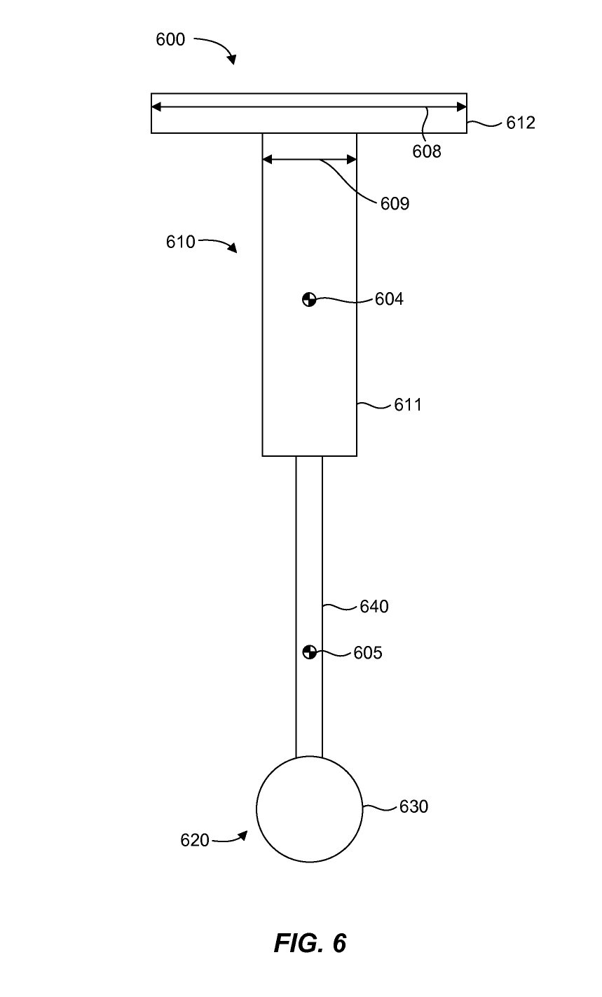

FIGS. 5A and 5B illustrate a buoy 500 for obtaining energy from a wave 501 in a body of water in accordance with an example of the present disclosure. The buoy 500 can include a floatation portion 510 to provide buoyancy for the buoy 500 in water. The buoy 500 can have a greater dimension in height 502 than in width 503. Accordingly, the buoy 500 can also include a ballast portion 520 to provide stability (e.g., rotational stability) for the buoy 500 such that the buoy 500 tends to restore itself to an equilibrium position after a small angular displacement. As illustrated in the figures, the ballast portion 520 can be proximate the floatation portion 510. In addition, the buoy 500 can include an energy conversion device 530.

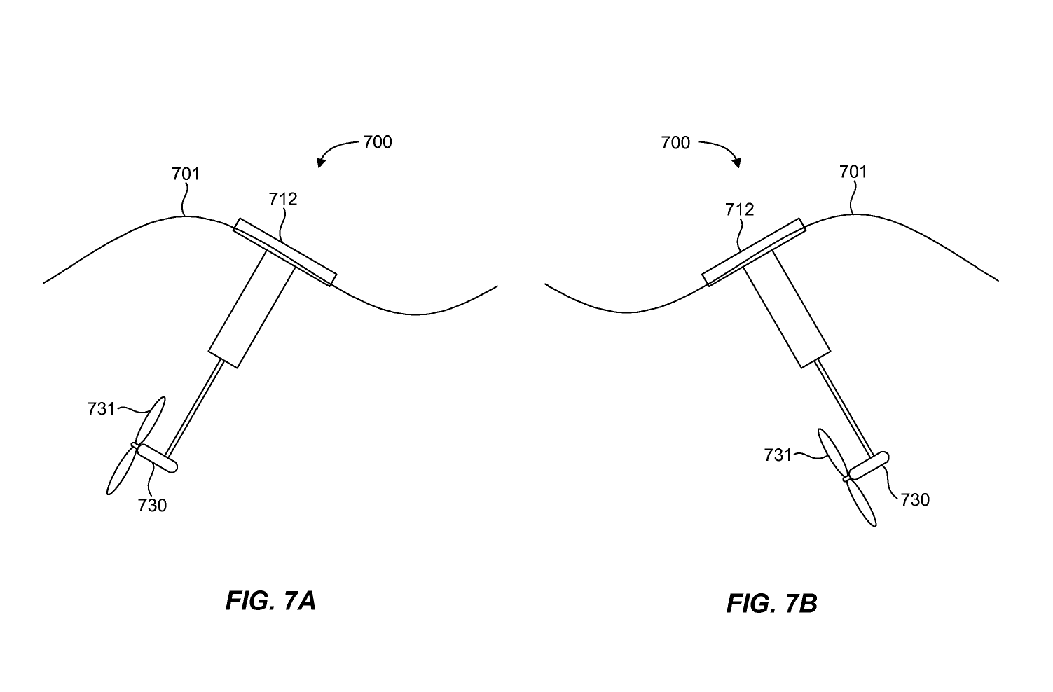

Rotational stability depends on the relative lines of action of forces on the buoy 500. The upward buoyancy force on the buoy 500 acts through the center of buoyancy 504, being the centroid of the displaced volume of fluid. The weight force on the buoy 500 acts through its center of gravity 505. The buoy 500 will be stable if the center of gravity 505 is beneath the center of buoyancy 504 because any angular displacement will then produce a “righting moment.” Many prior buoys suffer from instability caused by moments tending to move the buoy to a low energy state that orients the buoy in an undesirable orientation. For example, a buoy with an elongated buoy dimensional configuration having a greater dimension in height 502 than in width 503 (as illustrated) can have “negative stability” that will cause the buoy to become positioned on its side in the height dimension 502, which may render the buoy inoperable for its intended use. As described herein, a buoy can be designed with “positive stability” to prevent such an occurrence and return the buoy to a desired operating orientation, thus maintaining functionality of the buoy. In other words, the moments caused by negative stability can be counteracted by certain design elements or features to provide a buoy with sufficient positive stability to enable the buoy to function as desired. In one aspect, weight distribution (i.e., ballast, weighted lever arms, etc.) and/or buoyancy distribution of a buoy can be configured to counteract negative stability moments to return the buoy to a desired neutral position. Thus, for example, when the buoy 500 has an elongated buoy dimensional configuration with a greater dimension in height 502 than in width 503 (as illustrated), the ballast portion 520 can provide stability for a buoy configuration that would otherwise be unstable. Including the ballast portion 520 with such an elongated buoy can therefore enable the buoy to remain in, or return to, a desired operational orientation even when subjected to forces (e.g., waves) tending to tip or rotationally displace the buoy. The ballast portion 520 can therefore be utilized in any elongated buoy to maintain wave energy harvesting functionality throughout a variety of adverse conditions. In another example, discussed in more detail hereinafter (see FIG. 6), buoyancy of a buoy can be distributed such that a greater diameter of buoyant material is located at one end (i.e., the top end) than elsewhere to facilitate following a surface of a wave to counteract negative stability moments. Such design elements can therefore be utilized to control “wiggle” of a buoy by providing enough negative stability so that the buoy will move for effective operation in harvesting wave energy, but with enough positive stability so that the buoy will right itself and maintain a desired functional orientation. Thus, in one aspect illustrated in FIGS. 5A and 5B, the floatation portion 510 can be configured to maintain the buoy 500 substantially in the water and can be substantially maintained above the ballast portion 520 to facilitate a “pendulum motion” of the ballast portion 520. The ballast portion 520 can therefore be operable with the floatation portion 510 to move in a pendulum motion in directions 506, 507 in response to the wave 501 in the body of water. The wave 501 can angularly displace the buoy 500 and the righting moment can cause the pendulum motion of the ballast portion 510 through the water. The energy conversion device 530 can generate power in response to the pendulum motion of the ballast portion 520, thereby taking advantage of the potential energy available due to the angular displacement of the buoy 500. In one aspect, the ballast portion 520 can comprise the energy conversion device 530. In other words, the mass of the energy conversion device can provide some or all of the ballast for the ballast portion 520. The energy conversion device 530 can generate power by any suitable means known in the art. For example, the energy conversion device 530 can utilize pumping fluid, pumping air, electromagnetic induction, or energy conversion through any other type of mechanical motion.

FIG. 6 illustrates a buoy 600 for obtaining energy from a wave in a body of water in accordance with another example of the present disclosure. The buoy 600 is similar in many respects to the buoy 500 discussed above. For example, the buoy 600 includes a floatation portion 610, a ballast portion 620, and an energy conversion device 630. In this case, the buoy 600 includes an extension member 640 coupled to the floatation portion 610 and the ballast portion 620 to suspend the ballast portion 620 below the floatation portion 610. The extension member 640 can therefore increase the distance between the center of gravity 605 and the center of buoyancy 604 to improve stability of the buoy 600.

In addition, the floatation portion 610 can be configured to follow a surface of a wave to facilitate the pendulum motion of the ballast portion 620. For example, the floatation portion 610 can comprise a lower floatation portion 611 and an upper floatation portion 612. A diameter 608 of the upper floatation portion 612 can be greater than a diameter 609 of the lower floatation portion 611 to facilitate following a surface of a wave and enhancing the pendulum motion of the ballast portion 620. In one aspect, the different sizes of the lower and upper floatation portions 611, 612 can be used to provide variations in buoyancy. A variation in buoyancy can also be obtained by varying the density from the top to the bottom of the floatation portion 610.

FIGS. 7A and 7B illustrate a buoy 700 for obtaining energy from a wave 701 in a body of water in accordance with yet another example of the present disclosure. In particular, the buoy 700 includes an energy conversion device 730 that generates electricity. In this case, the energy conversion device 730 comprises a turbine generator that can move in response to water flowing past the turbine blades 731 as the energy conversion device moves through the water due to the pendulum motion described above. Thus, the energy conversion device 730 can “swing” through the water as an upper floatation portion 712 rides the slope of the wave 701. In other words, the relatively large diameter of the upper floatation portion can orient the buoy 500 to the slope of the wave 701, contributing to a greater range of motion for the energy conversion device 730 as it swings through the water with the changing slope of the wave 701.

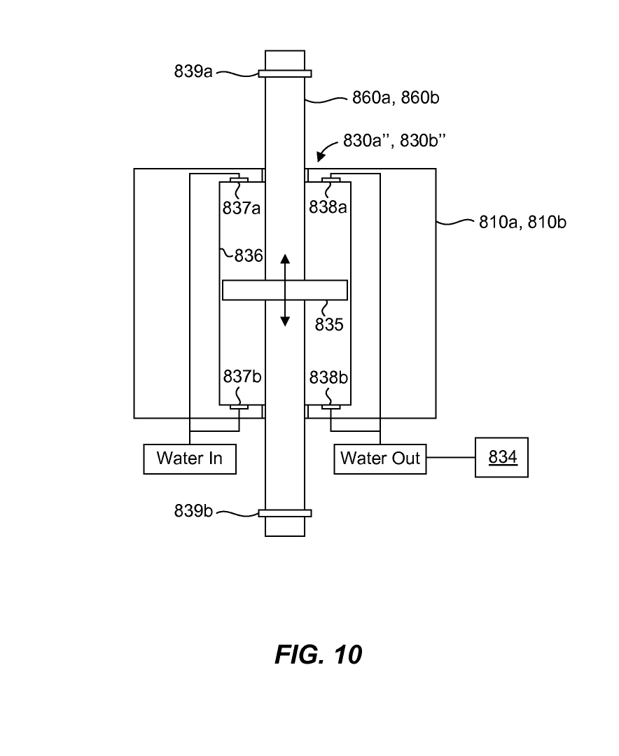

FIG. 8 illustrates a buoy 800 for obtaining energy from a wave 801 in a body of water in accordance with still another example of the present disclosure. The buoy 800 is similar in many respects to other buoys discussed hereinabove. For example, the buoy 800 includes a floatation portion 810, a ballast portion 820, and an energy conversion device 830a, 830b. The buoy 800 also includes an extension member 840 coupled to the floatation portion 810 and the ballast portion 820. In this case, the buoy 800 includes a framework 850 coupled to the floatation portion 810 to support the energy conversion device 830a, 830b. In one aspect, the buoy 800 can include a floatation portion 810a, 810b associated with the energy conversion device 830a, 830b to support the energy conversion device. In addition, the buoy 800 includes a connecting member 860a, 860b coupled to the ballast portion 820 and the energy conversion device 830a, 830b to couple the energy conversion device to the ballast portion. In one aspect, the energy conversion device 830a, 830b utilizes relative movement of the connecting member 860a, 860b and the floatation portion 810a, 810b to facilitate power generation or conversion. Accordingly, as the ballast portion 820 moves in a pendulum motion indicated at 806, the connecting member 860a, 860b can move in directions 861a, 861b relative to the floatation portion 810a, 810b, respectively. In addition, the floatation portion 810a, 810b can be rotatably coupled to the framework 850 at pivots 862a, 862b to facilitate movement of the connecting member 860a, 860b relative to the floatation portion 810a, 810b without binding. Power generation or energy conversion may be accomplished by any suitable means, such as is shown in FIGS. 9-11 and 13-14B discussed below.

In accordance with one embodiment of the present disclosure, a method for obtaining energy from a wave in a body of water is disclosed. The method can comprise obtaining a buoy having a floatation portion to provide buoyancy for the buoy in water, a ballast portion operable with the floatation portion to move in a pendulum motion in response to a wave in the body of water, wherein the floatation portion is substantially maintained above the ballast portion, and an energy conversion device to generate power in response to the pendulum motion of the ballast portion. Additionally, the method can comprise disposing the buoy in the body of water. In one aspect of the method, the floatation portion can be configured to follow a surface of the wave to facilitate the pendulum motion of the ballast portion. It is noted that no specific order is required in this method, though generally in one embodiment, these method steps can be carried out sequentially.

FIG. 9 illustrates an example of an energy conversion device 830a′, 830b′ for a buoy in accordance with the present disclosure. In particular, the energy conversion device 830a′, 830b′ is operable with the floatation portion 810a, 810b to generate power from movement of the connecting member 860a, 860b relative to the floatation portion 810a, 810b. In this example, the energy conversion device comprises an inductor that generates electricity via electromagnetic induction. The inductor includes a coil 832 of conducting material, such as copper wire. The connecting member 860a, 860b can include a ferromagnetic or ferrimagnetic material within the range of relative motion of the floatation portion 810a, 810b to form a core 833 for the inductor. Thus, relative motion of the connecting member 860a, 860b and the floatation portion 810a, 810b causes the core 833 to move relative to the coil 832 to generate electricity. The electricity can be used or stored, indicated at block 834, as desired.

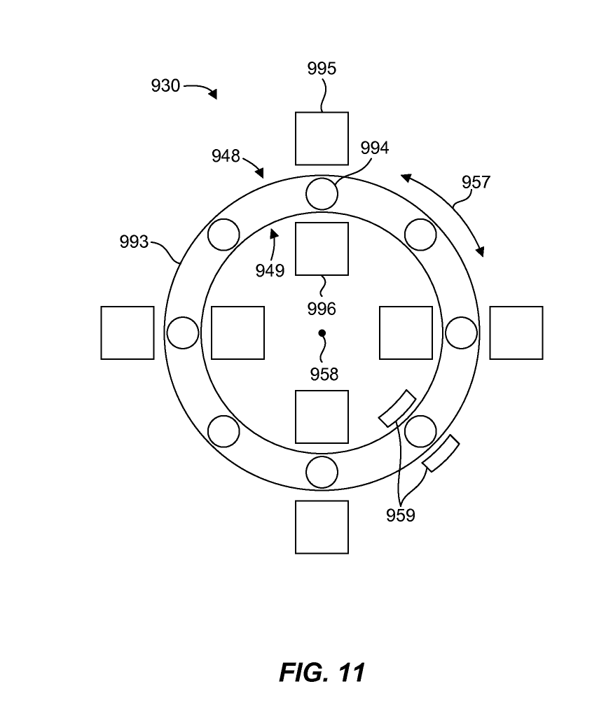

FIG. 10 illustrates another example of an energy conversion device 830a″, 830b″ for a buoy in accordance with the present disclosure. In this example, the energy conversion device comprises a pump that utilizes a piston 835 coupled to the connecting member 860a, 860b that moves within a cylinder 836 associated with the floatation portion 810a, 810b. The pump includes one-way inlet valves 837a, 837b and outlet valves 838a, 838b to regulate the flow of water through the pump. The pump can be configured to have a maximum stroke limited by stops 839a, 839b on the connecting member 860a, 860b. Thus, relative motion of the connecting member 860a, 860b and the floatation portion 810a, 810b causes the piston 835 to move relative to the cylinder 836 to pump water. The pumped water can be used to generate electricity or for any other suitable use as desired, indicated at block 834.

For the hydroelectric generation of energy, water can be pumped from one or more buoys to a floating hydroelectric generator or pumped to a land-based hydroelectric generator. Water can be pumped up into a floating water tower (so that many small pumps can pump water without working against each other) to provide water pressure for the hydroelectric generator. This option would, for example, allow the quick conversions of troubled or deficient energy sources, to ocean wave energy. For example, many nuclear reactors are built close to the coast. For these reactors, water from ocean waves can be pumped to turn existing generators which were initially designed to be run by steam produced by a nuclear reactor. These generators can be converted to run as a result of pumped water. For desalination plants, water can be pumped from one or more buoys to a reverse osmosis plant to create fresh water from salt water. Also, the buoys can be used to provide remote power to oil rigs, undeveloped areas, and locations where disaster relief is needed.

It is noted that if the desire is to pump water using the systems and methods described herein, a combination of an electricity generator (as in FIG. 9) can be used to generate electricity by induction, and the electrical power can be used to run a conventional water pump. This may be a more simple way of moving water, rather than having more complicated pistons, one way valves, etc., described with respect to FIG. 10.

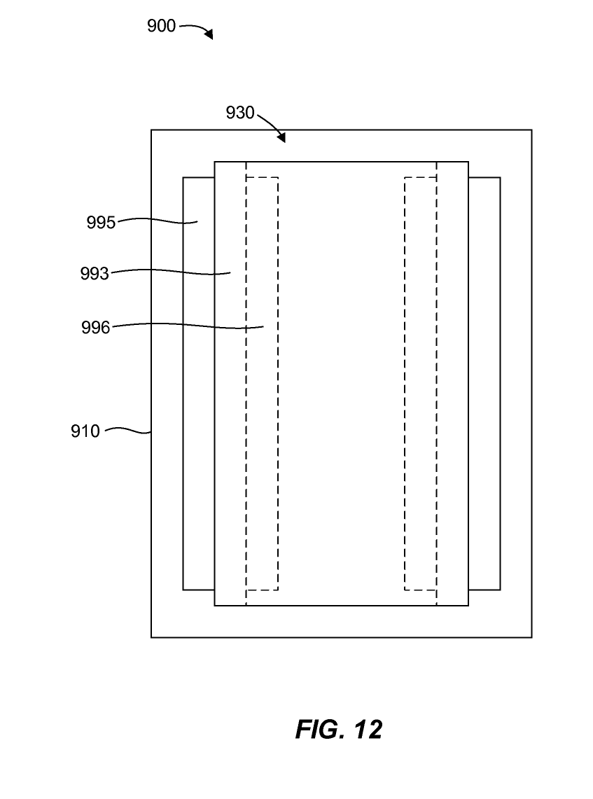

FIG. 11 illustrates a schematic representation of an energy conversion device 930 in accordance with another example of the present disclosure. The energy conversion device 930 can include a support member 993 defining a first side 948 and a second side 949. The energy conversion device 930 can also include one or more permanent magnets 994, which can be supported by the support member 993. In addition, the energy conversion device 930 can include one or more stator assemblies 995 disposed about the first side 948 of the support member 993, and one or more stator assemblies 996 disposed about the second side 949 of the support member 993. Relative movement of the permanent magnet 994 and the stator assemblies 995, 996 can generate electricity via electromagnetic induction. It should be recognized that the configuration of the energy conversion device 930 can also be adapted for use as an electric motor.

In one aspect, the relative movement of the permanent magnet 994 and the stator assemblies 995, 996 can be rotational, such as in direction 957 about an axis 958. In another aspect, the relative movement of the permanent magnet 994 and the stator assemblies 995, 996 can be translational, such as in a direction parallel to the axis 958.

As illustrated, the support member 993 can comprise a cylindrical configuration. Thus, the side 948 can be an exterior of the support member 993 and the side 949 can be an interior of the support member 993. A typical electric generator or motor includes a center shaft in support of a permanent magnet assembly that rotates inside stator assemblies. In contrast, no such central shaft exists in the energy conversion device 930, which makes a central or interior region of the device available to accommodate additional stator assemblies, such as the stator assemblies 996, “inside” of or interior relative to the permanent magnets 994. As a result, the number of stator assemblies can be increased compared to a typical generator/motor. In some embodiments, there are at least as many stator assemblies 996 interior of the permanent magnets 994 as stator assemblies 995 exterior of the permanent magnets 994, which can at least double the power generation capabilities over a conventional generator configuration with the same amount of permanent magnets and outer stator assemblies. In addition, the cylindrical support member 993 configuration can represent a reduced volume and mass of a rotatable permanent magnet assembly of a typical generator/motor, which can reduce the force or torque needed to rotate the permanent magnets, resulting in increased efficiency and greater power generation.

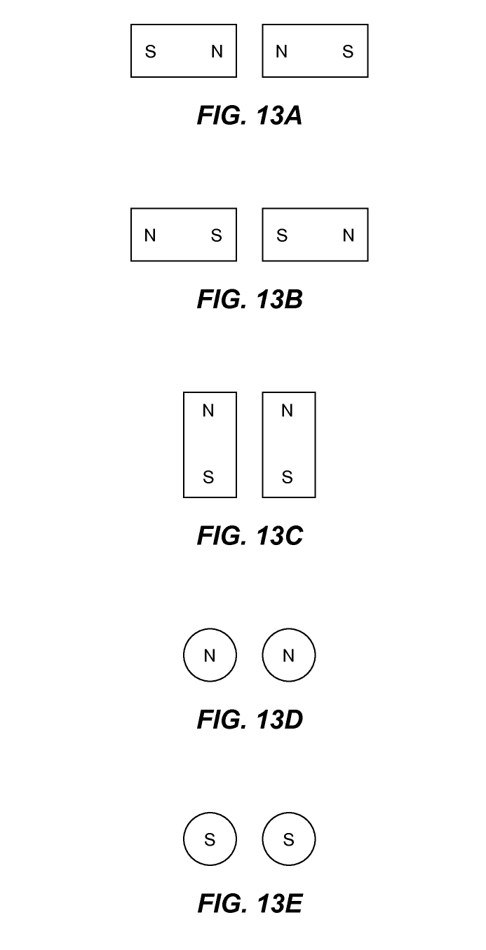

In one aspect, the energy conversion device 930 can have a large diameter (e.g., greater than 3 meters) with a large empty center, which can increase displacement while reducing the mass. This can be beneficial for use in a buoy in accordance with the present disclosure in that the desired buoyancy can be maintained for the buoy to float at a desired depth or at the surface of the water without sinking, while at the same time decreasing size and material costs. For example, as illustrated in FIG. 12 the energy conversion device 930 can be associated with or disposed in a floatation portion 910 of a buoy 900 that can be utilized for power generation utilizing wave energy. The energy conversion device 930 can also provide increased surface area, which can provide more exposure to the permanent magnets, thereby increasing the power generation capacity of the device.

In one aspect, a hybrid permanent magnet/stator assembly can be employed to improve coupling of flux or focus flux on the stator assembly to increase power output due to stator assemblies 995, 996 being located on opposite sides of the support member 993.

A cap (not shown) can be added to one end of the energy conversion device 930 to form a support member similar to a drum, which may provide an attachment point at the center of rotation (e.g., the axis 958) for drilling or other mechanical equipment turning operation. The support member 993 can be of a solid or a framework construction, utilizing multiple subcomponents.

In one aspect, the support member 993 can be movably supported by one or more magnetic bearings 959. Magnetic bearings can be included to reduce frictional forces, thus further decreasing the force or torque needed to rotate the permanent magnets 994 thereby increasing efficiency and generating more electricity with the same force or torque.

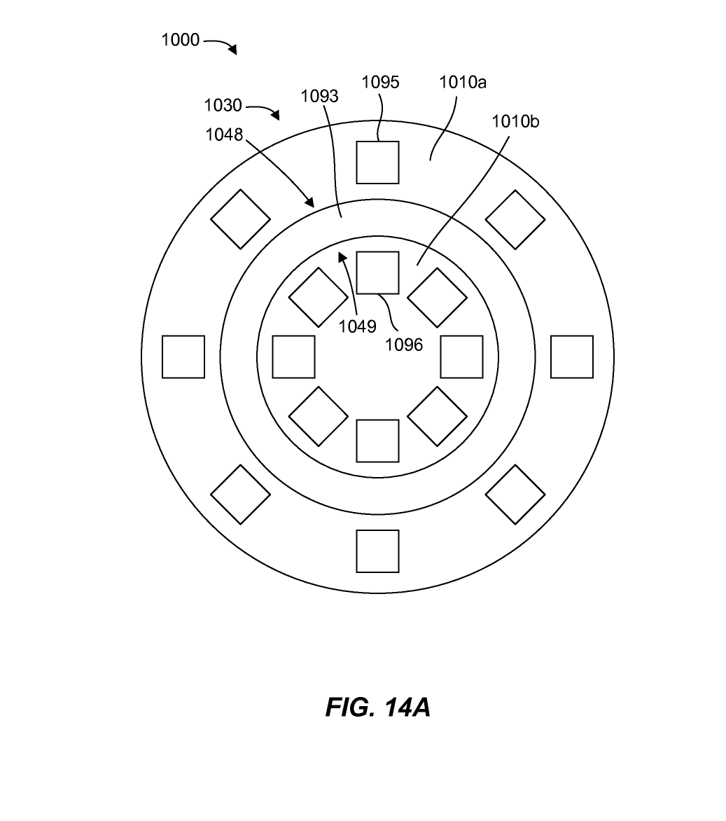

FIGS. 13A-13E illustrate several different magnetic bearing arrangements, which can be permanent magnets and/or electromagnets to provide repulsive force to push two moving parts away from each other. FIGS. 13A and 13B illustrate in-line magnetic bearings. FIG. 13C illustrates parallel pole magnetic bearings. FIGS. 13D and 13E illustrate monopole magnetic bearings. A magnetic bearing can prevent friction and energy loss. Without the need for lubricants, which can be combustible, and no heat due to friction, magnetic bearings can eliminate a potential fire hazard and improve safety.

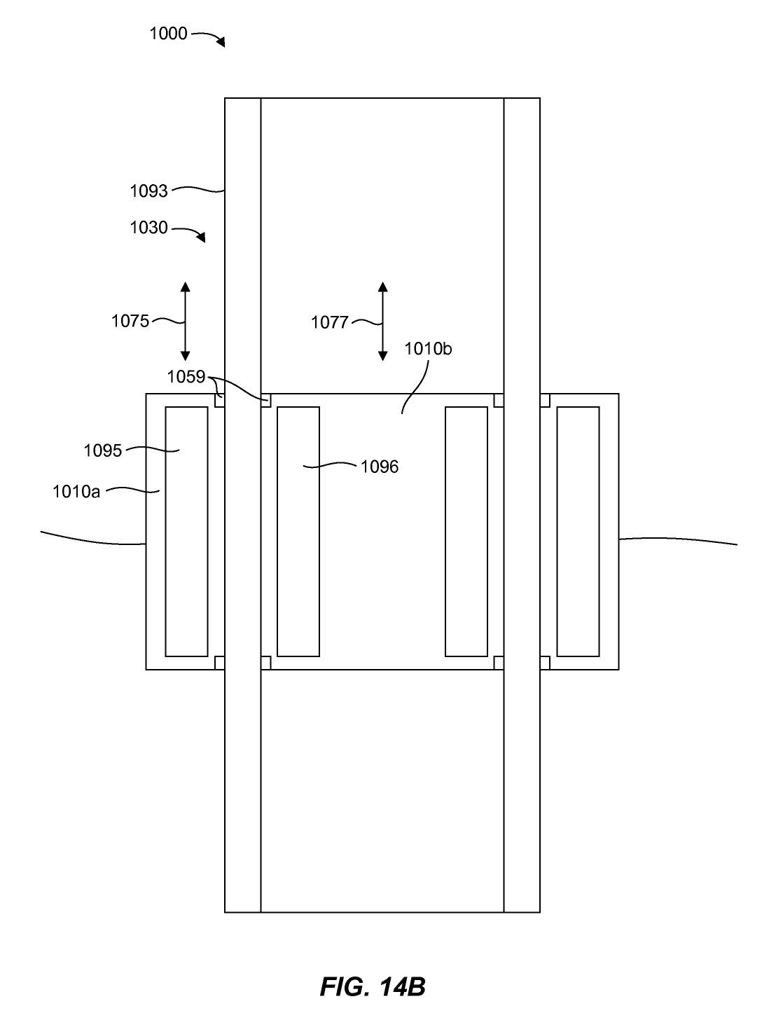

FIGS. 14A and 14B illustrate a schematic representation of a buoy 1000 for obtaining energy from a wave in a body of water in accordance with another example of the present disclosure. The buoy 1000 can include floatation portions 1010a, 1010b to provide buoyancy in water. The buoy 1000 can also include an energy conversion device 1030 associated with the floatation portions 1010a, 1010b. The energy conversion device 1030 is similar in many respects to the energy conversion device 930 of FIG. 11. For example, the energy conversion device 1030 can include a support member 1093 defining a first side 1048 and a second side 1049, a permanent magnet (obscured from view) supported by the support member 1093, and stator assemblies 1095, 1096 disposed about different sides 1048, 1049 of the support member 1093, which can have a cylindrical configuration. Thus, the side 1048 can be an exterior of the support member 1093 and the side 1049 can be an interior of the support member 1093. In this case, the stator assembly 1095 is coupled to the floatation portion 1010a, and the stator assembly 1096 is coupled to the floatation portion 1010b. The floatation portions 1010a, 1010b are moveable relative to the support member 1093 such that a wave in a body of water causes relative movement of the stator assemblies 1095, 1096 and the permanent magnet to generate electricity via electromagnetic induction.

As shown in FIG. 14B, the floatation portions 1010a, 1010b can be translatable in directions 1075, 1077 relative to the support member 1093. The floatation portions 1010a, 1010b can move together or independent of one another. Thus, each floatation portion 1010a, 1010b can be supported independently by ocean waves and move independently of each other. The support member 1093 can be bottom mounted (e.g., anchored to the sea floor) or connected to a floating structure. Therefore, in one aspect, the buoy 1000 can function as a point absorber or generate energy by riding the slope of a wave. A magnetic bearing 1059 can be included to facilitate relative movement of the floatation portions 1010a, 1010b and the support member 1093. It should be recognized that the support member 1093 can be of any suitable configuration. In one aspect, the support member can have a planar configuration for all or a portion of the support member. In another aspect, the support member 1093 can comprise multiple components that may or may not be directly coupled to one another. The support members of the energy conversion devices discussed above may be sufficiently rigid to withstand deformations that would grossly deform the support members under typical operating loading conditions. It should be recognized, however, that a support member of an energy conversion device as disclosed herein may be flexible and configured to bend or deform under typical operating loading conditions, as discussed below.

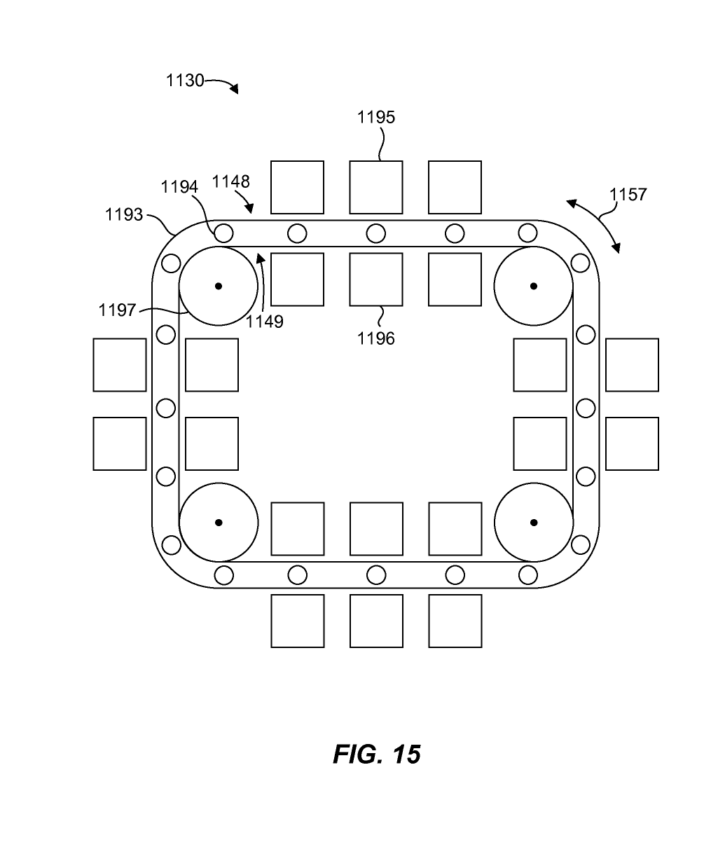

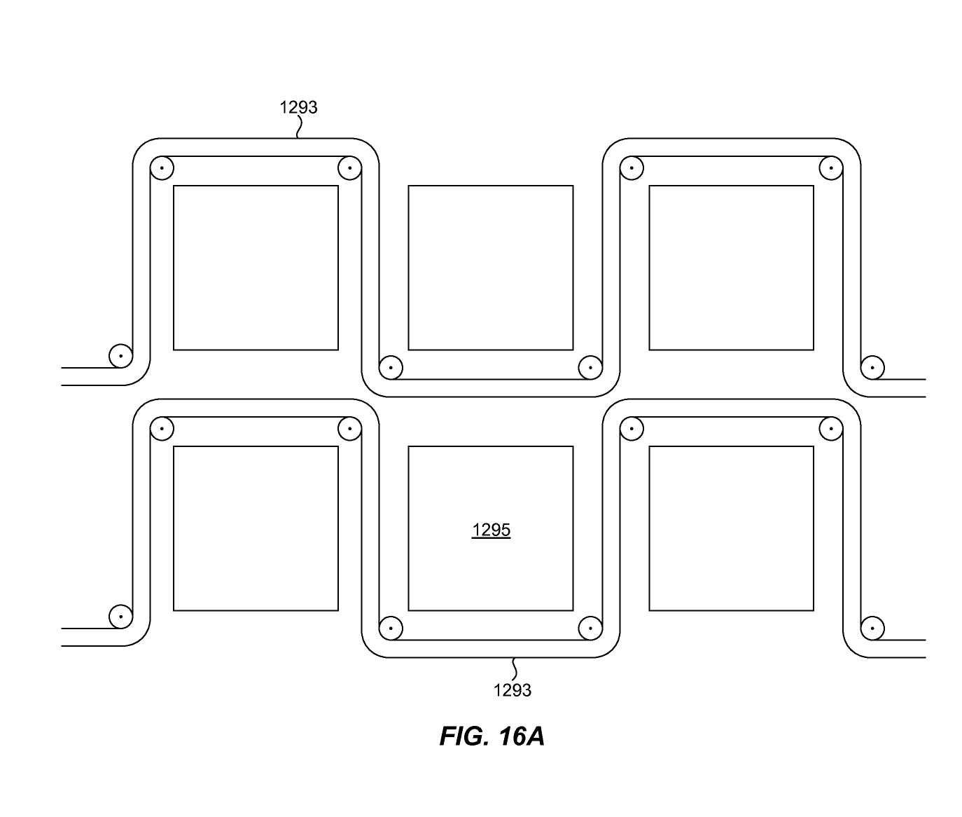

FIG. 15 illustrates a schematic representation of an energy conversion device 1130 in accordance with another example of the present disclosure. The energy conversion device 1130 is similar in many respects to the energy conversion device 930 of FIG. 11. For example, the energy conversion device 1130 can include a support member 1193 defining a first side 1148 and a second side 1149, one or more permanent magnets 1194 supported by the support member 1193, and stator assemblies 1195, 1196 disposed about different sides 1148, 1149 of the support member 1193. Thus, the side 1148 can be an exterior of the support member 1193 and the side 1149 can be an interior of the support member 1193. In this case, the support member 1193 is configured to be flexible (e.g., a belt configuration). The support member 1193 for the permanent magnets 1194 can be disposed about one or more rotary members 1197 to facilitate rotational and/or translational movement of the support member 1193 generally in direction 1157. Magnetic bearings may be used at 1197 to facilitate rotational and/or translational movement of the support member 1193 generally in direction 1157. Thus, the flexible support member 1193 can be routed between the stator assemblies 1195, 1196 to cause the permanent magnets 1194 to come in close proximity to the stator assemblies for generation of electricity. FIGS. 16A and 16B illustrate non-limiting examples of routing configurations for flexible support members 1293, 1393 about two or more sides of stator assemblies 1295, 1395 in energy conversion devices. In one aspect, the flexible support member 1293 can be routed about all sides of the stator assembly 1295, thus enhancing the power generation capabilities of the energy conversion device. Thus, a flexible support member for permanent magnets can be bent into any suitable shape or routed in any suitable configuration, such as to position the permanent magnets in proximity to the stator assemblies. In one aspect, flexible magnets can be utilized with a flexible support member.

Although the flexible support members 1193, 1293, 1393 are illustrated as endless belts or loops, it should be recognized that a flexible support member can terminate at opposite ends and can facilitate bi-directional relative translational movement with the stator assemblies, such as with the energy conversion device 1030 of FIGS. 14A and 14B.

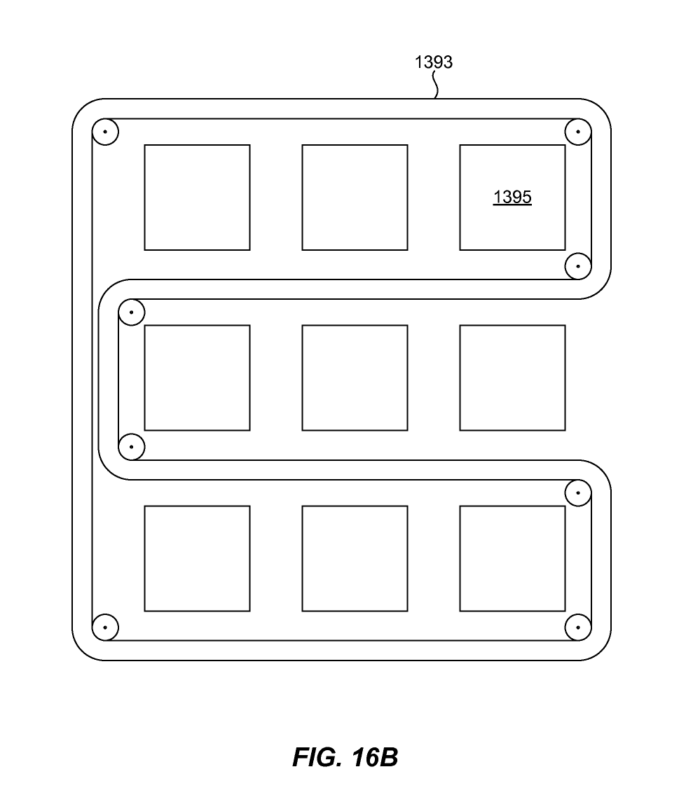

FIG. 17 illustrates a schematic representation of an energy conversion device 1430 in accordance with another example of the present disclosure. The energy conversion device 1430 is similar in many respects to some other energy conversion devices disclosed herein. For example, the energy conversion device 1430 can include a support member 1493 defining a first side 1448 and a second side 1449, one or more permanent magnets 1494 supported by the support member 1493, and stator assemblies 1495, 1496 disposed about different sides 1448, 1449 of the support member 1193. The support member 1493 can be rigid or flexible. In this case, each permanent magnet 1494 is configured to extend about at least one side of at least one stator assembly. In one aspect, one or more of the permanent magnets 1494 can extend between adjacent stator assemblies 1495, 1496 on the same side 1448, 1449 of the support member 1493, thus positioning permanent magnets on opposite sides of the same stator assembly. This “three-dimensional” positioning of the permanent magnets 1493 relative to the stator assemblies 1495, 1496 can align a north magnetic pole on one side of the stator assembly and a south magnetic pole on the opposite side of the stator assembly, thereby increasing the power output of the stator assembly. In other words, the electrons in the coils of the stator assemblies are driven by permanent magnets on both sides of the stator assemblies, creating a much stronger generator/motor. This can enable lower grade magnets to create higher performance motors/generators that would otherwise be possible with low grade magnets, thus decreasing costs. It should be recognized that an energy conversion device may only include a stator assembly on one side of the device, such as the stator assemblies 1495 on the first side 1448 with no stator assemblies on the second side 1449.

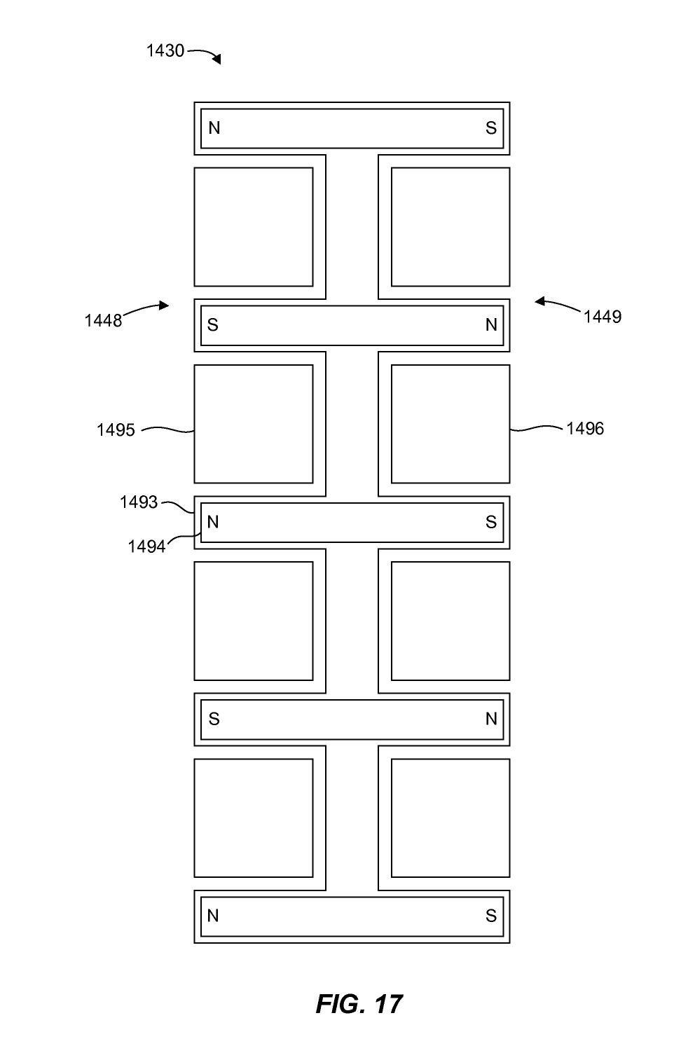

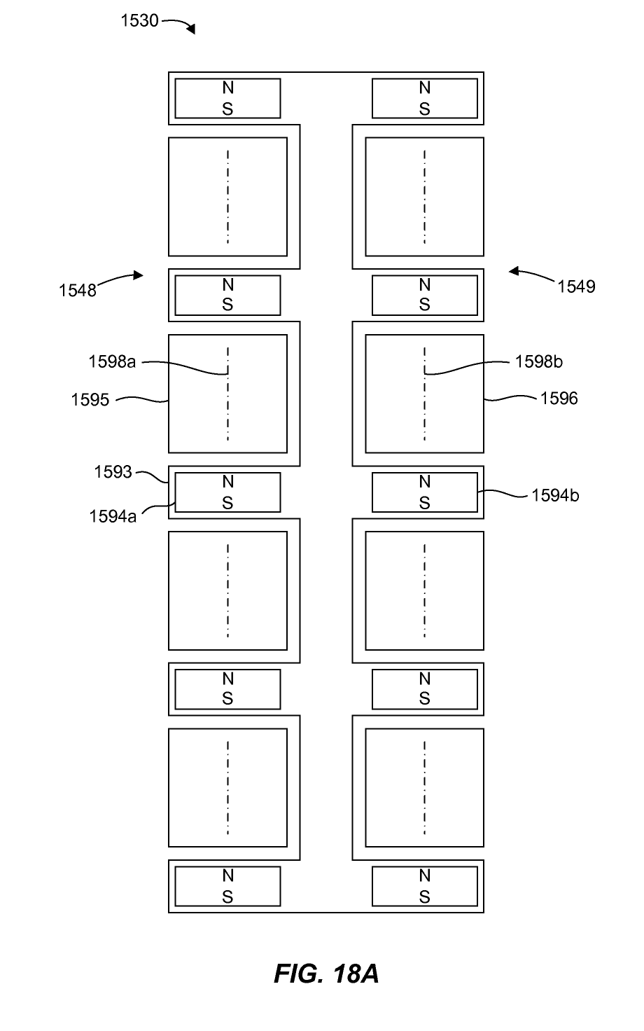

FIG. 18A illustrates a schematic representation of an energy conversion device 1530 in accordance with another example of the present disclosure. The energy conversion device 1530 is similar in many respects to the energy conversion device 1430 of FIG. 17. In this case, different permanent magnets 1594a, 1594b are disposed on first and second sides 1548, 1549 of a support member 1593, respectively. In addition, the magnetic poles of the permanent magnets 1594a, 1594b are oriented in the same direction, with north magnetic poles all oriented in the same direction and south magnetic poles all oriented in the same direction. With stator assemblies 1595 between the permanent magnets 1594a, stator assemblies 1596 between the permanent magnets 1594b this configuration of permanent magnets positions a north magnetic pole and a south magnetic pole on opposite sides of the stator assemblies. In one aspect, the stator assemblies 1595, 1596 can have coils that are wound around stator axes 1598a, 1598b, respectively. The orientation of the stator assemblies 1595, 1596 can be such that the axes 1598a, 1598b align with the magnetic poles of the permanent magnets 1594a, 1594b, respectively, which can better align the permanent magnets with the direction of electron flow in the stator assemblies. This coil orientation of stator assemblies may vary from a standard motor/generator coil orientation by as much as 90%. An alternate layout may include stator coils aligned parallel to the direction of motion of the permanent magnets in relation to the stators.

FIG. 18B illustrates another view of the permanent magnet configuration of the energy conversion device 1530. In FIG. 18A, the north magnetic poles are at the top and the south magnetic poles are at the bottom. This arrangement can be alternated for different groups of permanent magnets supported by the support member 1593. Thus, as shown in FIG. 18B, a first group of permanent magnets 1594 can have north magnetic poles oriented on top, and a second group of permanent magnets 1594′ can have south magnetic poles oriented on top. This configuration can alternate around the support member 1593. Reference number 1557 indicates a direction of movement for the support member and permanent magnets. Although, as with other examples disclosed herein, it should be recognized that the support member 1593 can be configured to facilitate bi-directional translational relative movement with the stator assemblies 1595, 1596.

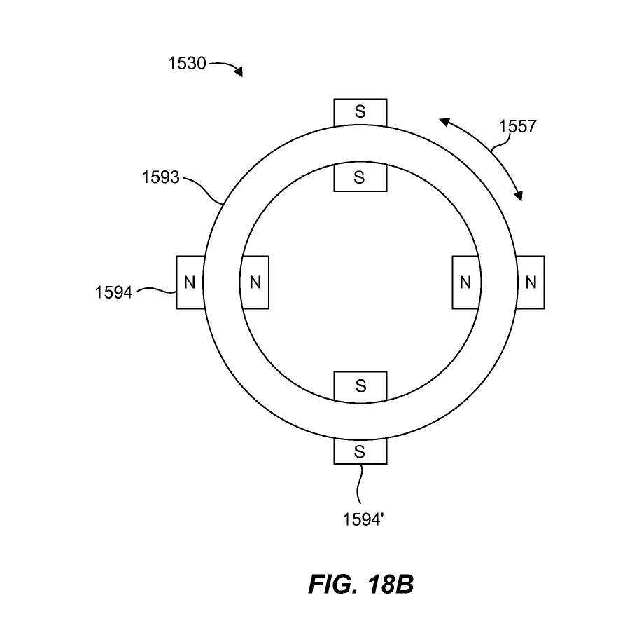

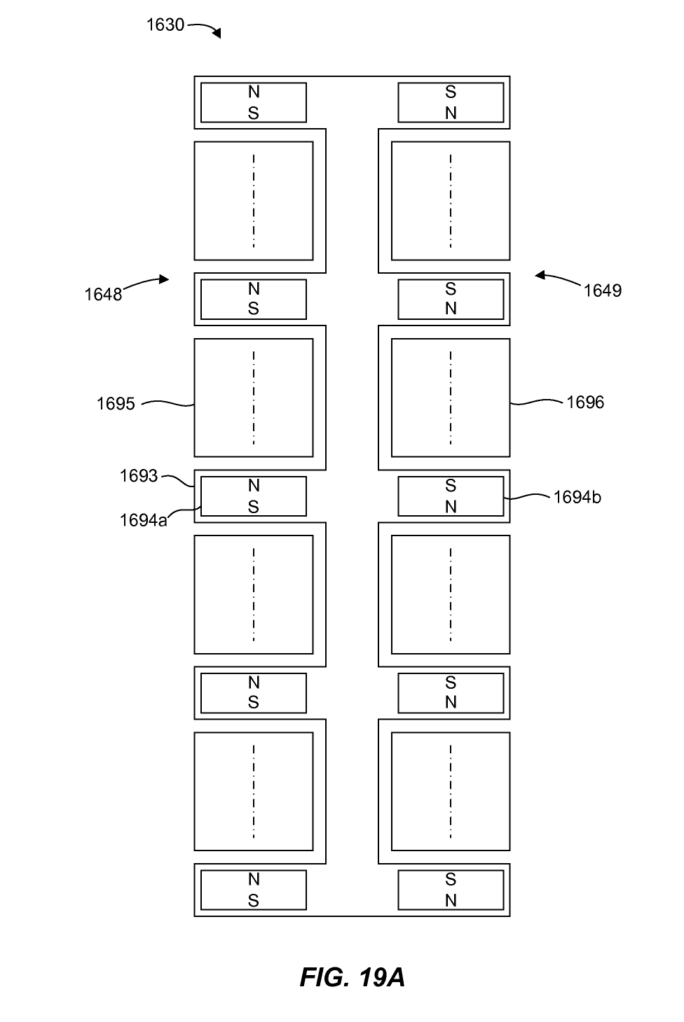

FIG. 19A illustrates a schematic representation of an energy conversion device 1630 in accordance with another example of the present disclosure. The energy conversion device 1630 is similar in many respects to the energy conversion device 1530 of FIG. 18A. In this case, permanent magnets 1694a, 1694b disposed on first and second sides 1648, 1649 of a support member 1693, respectively, can have magnetic poles that are oriented in the opposite direction. Thus, the permanent magnets 1694a on the first side 1648 can all have north magnetic poles oriented in one direction, and the permanent magnets 1694b on the second side 1649 can all have north magnetic poles oriented in the opposite direction.

FIG. 19B illustrates another view of the permanent magnet configuration of the energy conversion device 1630. As with the energy conversion device 1530 as shown in FIG. 18B, the energy conversion device 1630 can have a permanent magnet arrangement that is alternated for different groups of permanent magnets 1694, 1694′ supported by the support member 1693.

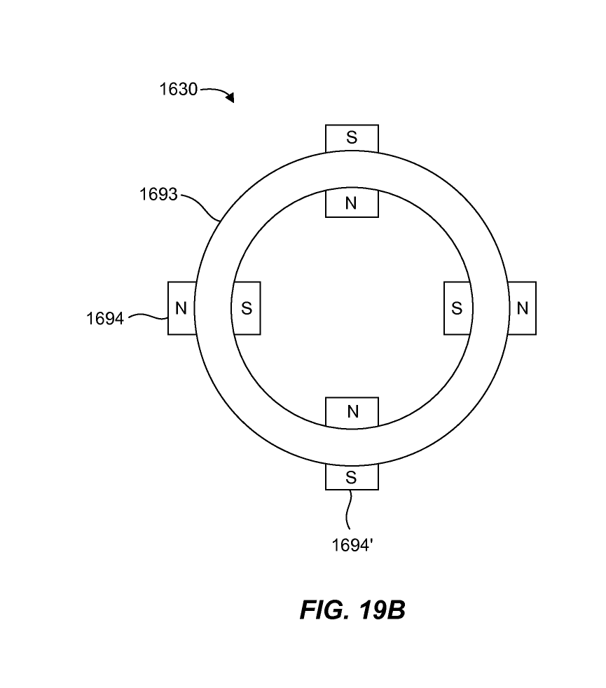

FIGS. 20A-20C illustrate energy conversion devices 1730, 1830, 1930 in accordance with several additional examples of the present disclosure. The energy conversion devices 1730, 1830, 1930 have the same basic permanent magnet and stator assembly relationships as the energy conversion devices 1430, 1530, 1630, respectively. In this case, however, support members 1793, 1893, 1993 of the energy conversion devices are configured to rotate about axes 1799, 1899, 1999, respectively.

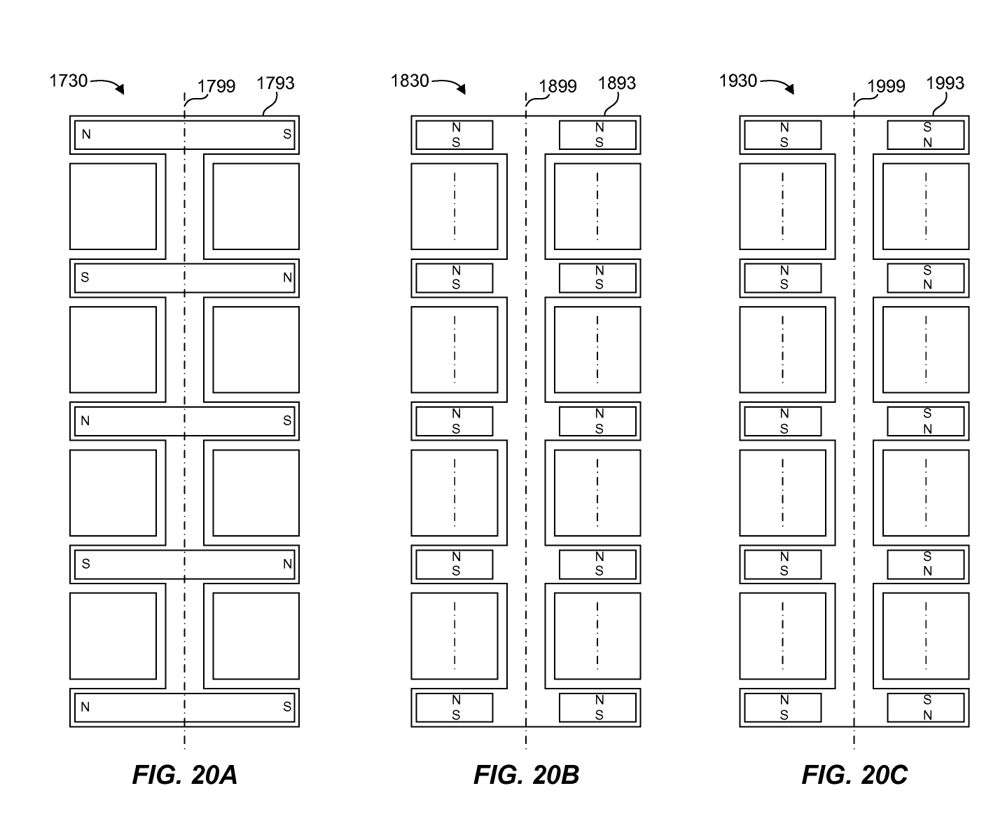

FIGS. 21A and 21B illustrate a cross configuration for maintaining stability of an array of buoys 2000 in the water. Here, the base buoy 2020 and the plurality of movable buoys 2030a, 2031a, 2030b, 2031b are arranged in a cross configuration with the base buoy disposed at a center of the cross configuration. The cross configuration locates movable buoys extending out in four opposite directions from the base buoy to provide floatation stability for the array of buoys. The cross configuration also enables energy harvesting vertical motion of the movable buoys from waves encountering the array of buoys from multiple directions.

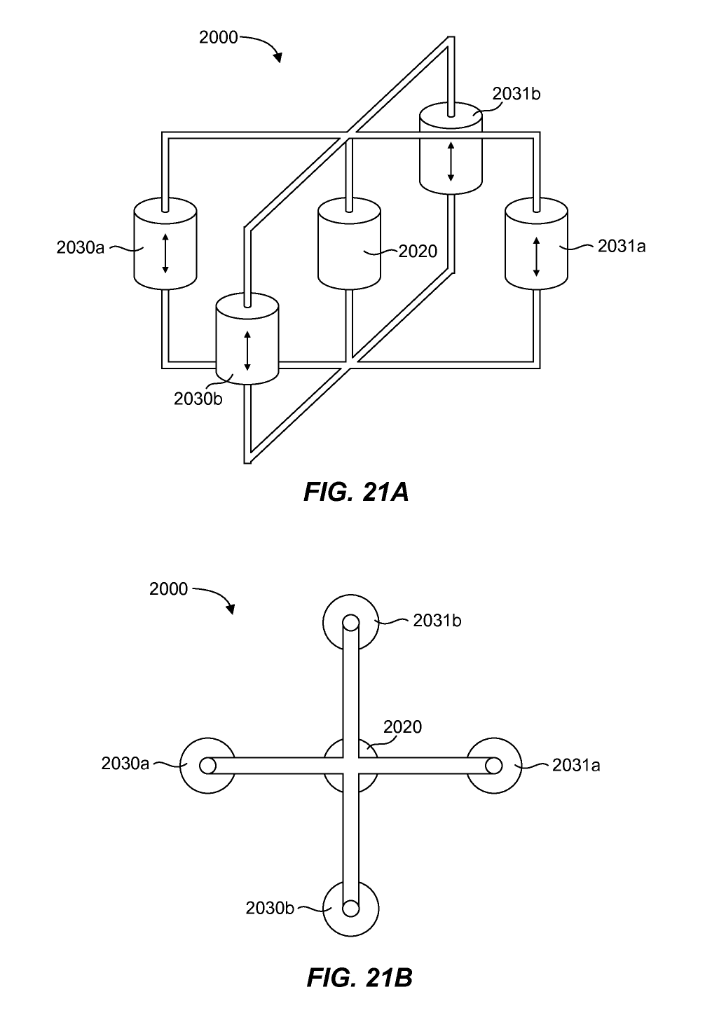

FIGS. 22A and 22B illustrate a configuration for maintaining stability of an array of buoys 2100 in the water as well as for extending the array to include any number of movable buoys and/or base buoys. For example, a base buoy 2120a can be associated with one or more movable buoys 2130a, 2131a in a positional relationship as disclosed herein. This basic arrangement can be repeated any number of times to expand or enlarge the array, as illustrated with base buoys 2120b and 2120c, and movable buoys 2130b, 2131b and 2130c, 2131c, respectively. The base buoys can serve as stabilizing buoys for the array. The base buoys can be connected by one or more framework members, such as lateral members 2116a, 2116b. Alternatively, or in addition, the base buoys can be connected by one or more lateral framework members 2117a, 2117b that extend between framework portions proximate to movable buoys. In one aspect, the lateral framework members connecting base buoys can form rigid connections or pivoting connections. A pivoting connection may result in reduced stress on the framework as an array grows in size by allowing the base members to move relative to one another to follow a wave without suspending a base member in the air above the water. In this case, a range of motion for a pivoting connection can be limited to prevent the framework from folding up and collapsing or damaging components of the array. It should be appreciated that the various components of an array of buoys can be arranged to provide stability and/or expand the number of base buoys and/or movable buoys in the array utilizing the concepts and positional relationships disclosed herein.

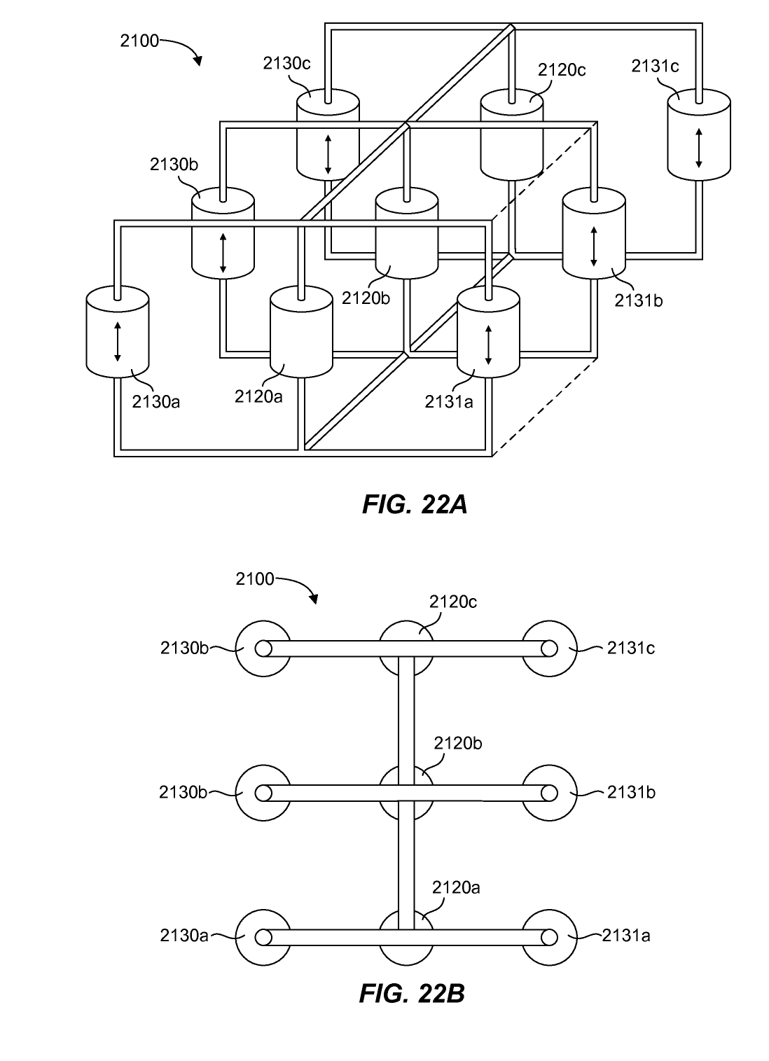

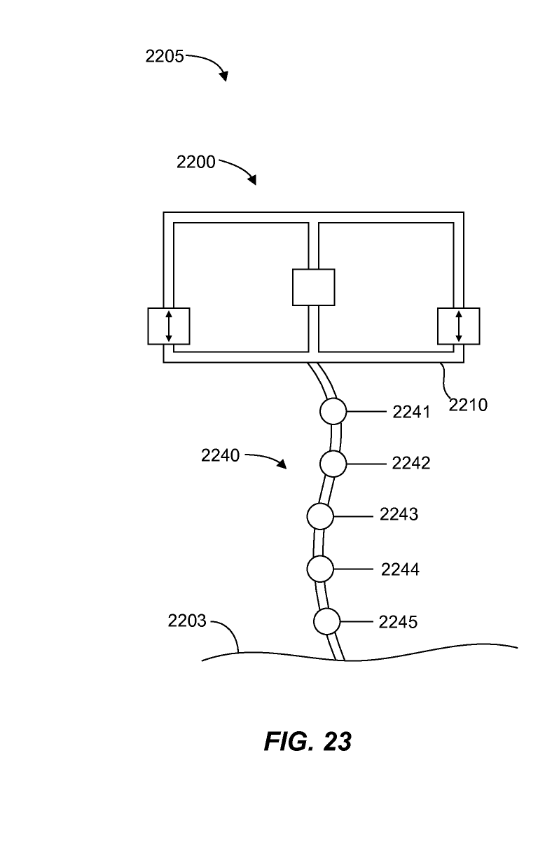

FIGS. 23 and 24 each illustrate a system for obtaining energy from surface waves, comprising an array of buoys coupled to a buoyant tether, which can be used to secure or attach an array of buoys to an object, such as the ocean floor or a floating support of some type, such as a ship or oil rig. A buoyant tether as disclosed herein can therefore serve as a mooring line, a tow line, or any other suitable type of tether.

FIG. 23 illustrates a system 2205 having an array of buoys 2200 coupled to a tether 2240 and secured or attached to an object 2203, similar to that shown in FIG. 2. However, in this example, the tether is a buoyant tether which includes a plurality of attached buoyancy devices 2241, 2242, 2243, 2244, 2245 coupled along the length of the buoyant tether. Other structures are similar to those previously described, such as in FIGS. 1-4C. In FIG. 23, however, the attached buoyancy devices can be constructed of any suitable buoyant material and can be coupled to the buoyant tether at any position. By contrast, the buoyant tether need not comprise attached buoyancy devices, but can comprise built in buoyancy. In one aspect, the buoyant tether 2240 can be coupled to the array of buoys 2200 via a framework 2210 of the array of buoys.

In further detail, the buoyant tether 2240 can comprise a cable or a utility line. The utility line can transfer electricity, pumped fluid, or gas to or from the array of buoys. In very deep water, a very long cable or utility line might otherwise exert considerable drag on the array of buoys, which could reduce the movement of the moveable buoys and thereby reduce the amount of energy captured by the array of buoys. The mass of the cable or utility line can be supported by built in buoyancy or attached buoyancy devices. Such support will reduce the peak load which would exist at the top of the cable or utility line where it connects to the array of buoys, which can thereby increase the life of the cable or utility line and reduce the risk of breakage or other damage during rough weather. In further detail regarding the buoyant tether, by providing a self-supporting tether in the water with respect to its own weight or mass, movable buoys of the array of buoys can move with freedom up and down with the ocean waves without losing momentum, e.g., a heavy or non-buoyant tether may cause the array of buoys to be being forced into a submersed or partially submersed state, diminishing the effectiveness of the device.

FIG. 24 illustrates a system 2305 having an array of buoys 2300 coupled to a buoyant tether 2340, again, similar to that shown in FIG. 2. However, in this example, the buoyant tether 2340 comprises a primary buoyant tether 2350a and a plurality of secondary buoyant tethers 2350b and 2350c which act to secure the array of buoys to an object 2303. In this example, the secondary buoyant tethers 2350b, 2350c are coupled to the primary buoyant tether 2350a via a tensioner 2360, which can facilitate load sharing among the secondary tethers. The tensioner 2360 can include a bungee cord, spring, shock, etc. attached across a loop in the tether cable allowing force from a base buoy 2320 to pull the bungee cord, spring, or shock to release additional line for the tether, thus facilitating a change in the tether length, which can allow adjustment of the tether to compensate for changing ocean height due to waves and tides. As illustrated, the primary buoyant tether and the plurality of secondary buoyant tethers are supported by attached buoyancy devices 2341, 2342, 2343, 2344, 2345, 2346, and 2347. The attached buoyancy devices can be constructed of any suitable buoyant material. Further, at least one of the primary buoyant tether and the secondary buoyant tethers can be constructed of buoyant material or comprise built in buoyancy.

The tensioner 2360 can couple the primary buoyant tether 2350a to the plurality of secondary buoyant tethers 2350b, 2350c. During storms and rough ocean waves, large wind loads, currents, and/or wave action, the array of buoys can be battered about. Some larger arrays of buoys can benefit from multiple tethers to reduce the peak loads on the tether as a whole and to prevent breakage and loss of moorings. Attaching one or more tensioners to the primary buoyant tether enables the system 2305 to load share the force across a plurality of secondary buoyant tethers. In further detail, there can be multiple tethers that couple at different locations on the array of buoys, or can couple to separate arrays of buoys, either through a tensioner or directly to the object or ocean floor. Each tether can have its own electrical connection to an inductor of an energy conversion device, or the tethers can be connected electrically together, such as in series or in parallel.

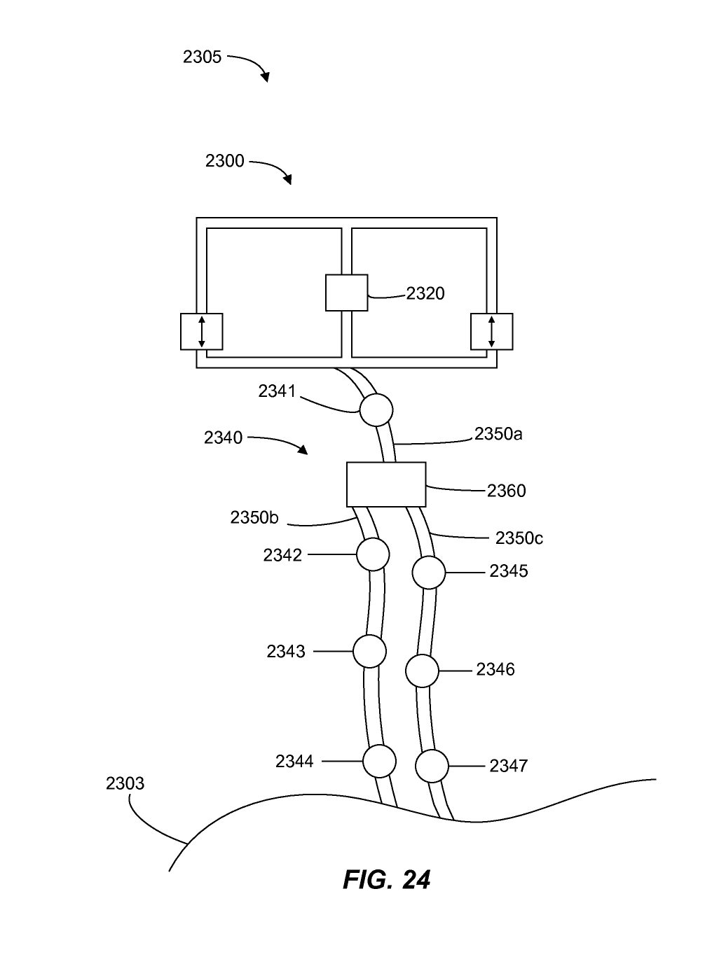

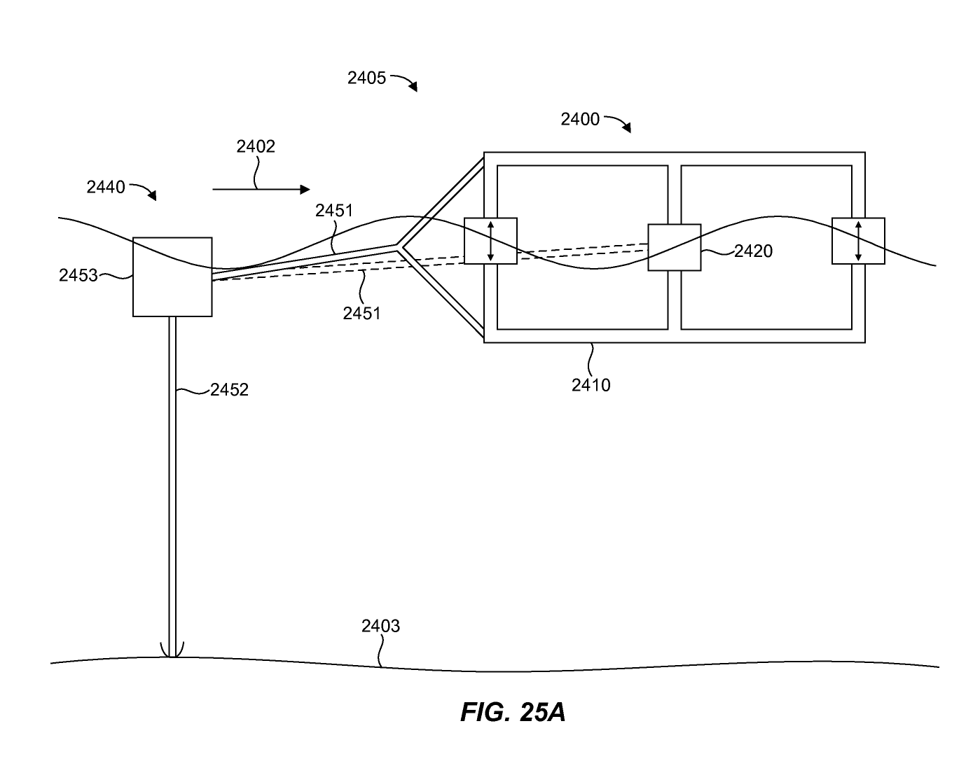

FIG. 25A illustrates a system 2405 for obtaining energy from surface waves in accordance with another example of the present disclosure. As with other examples described herein, the system 2405 can include an array of buoys 2400 and a buoyant tether 2440 coupled to the array of buoys. In this case, the buoyant tether can include a lateral tether portion 2451 coupled to the array of buoys, a vertical tether portion 2452 to attach to an object 2403 (e.g., a mooring line to the ocean floor), and a lateral support buoy 2453 coupled between the lateral tether portion and the vertical tether portion. The buoyant tether can be coupled to the array of buoys via a framework 2410 and/or a base buoy 2420 of the array of buoys. In one aspect, the lateral support buoy 2453 can substantially provide buoyancy for the lateral tether and/or the vertical tether. Thus, the lateral support buoy 2453 can support the weight of a tether/utility line going to the ocean floor. Waves propagating in direction 2402 can cause the array of buoys 2400 to be oriented away from the lateral support buoy 2453, thus extending the lateral tether portion substantially horizontal in the same direction due to the attachment of the vertical tether portion 2452 to the ocean floor. Running the lateral tether portion from the array of buoys 2400 horizontally to the lateral support buoy can allow the array of buoys to “fly” on the ocean surface much like a kite on the wind, allowing movement of the array of buoys with the ocean waves in a substantially vertical direction, which is in the same direction as buoyant forces acting on the buoys. This tethering configuration can therefore closely align the buoy motion with the direction of buoyant forces acting on the buoys. This tethering configuration can have advantages over other tethering configurations. For example, in some tethering configurations, an array of buoys is tethered directly or straight downward to the ocean floor (see, e.g., FIG. 2) causing the array of buoys to support at least some of the mass of the tether, which creates a resistance force countering the up/down movement of buoyant forces causing the buoy to tilt at an angle. Supporting the vertical or mooring tethering portion 2452 with the lateral support buoy 2453, as in FIG. 25A, can reduce or minimize the tilting effect or misalignment of buoy movement and buoyant force direction, such as can occur with other tethering configurations. In one aspect, as described above, the lateral tether 2451 and/or the vertical tether 2452 can comprise an attached buoyancy device coupled thereto and/or have built in buoyancy.

FIG. 25B illustrates the system 2405 when subjected to an extreme wave. As shown in the figure, by having the lateral tether portion 2451 coupled to the tether support buoy 2453, which is coupled to the ocean floor 2403 via the vertical tether portion 2452, the array of buoys 2400 can be prevented from “surfing” down the slope of the wave and snapping the tether line at the bottom of the wave. With this configuration, slack in the lateral tether portion 2451 is removed as the array of buoys 2400 rides a wave, thus preventing or minimizing horizontal speed/motion of the array of buoys. The lateral tether portion 2451 can therefore hold the horizontal position of the array of buoys 2400 and counteract the surfing force acting on the array of buoys caused by the wave propagating in direction 2402. The lateral tether portion 2451 can also hold the leading edge of the array of buoys 2400 so that breaking waves will crash over and not lift up or flip the array of buoys.

Although the tether configuration illustrated in FIGS. 25A and 25B can help the array of buoys survive an extreme wave, a site survey can be performed, such as through archives and satellite data, to identify areas that are prone to extreme waves (i.e., waves greater than 30 m tall with unusually steep slopes) so that power production sites can be located in areas where there is a lower risk of an extreme wave.

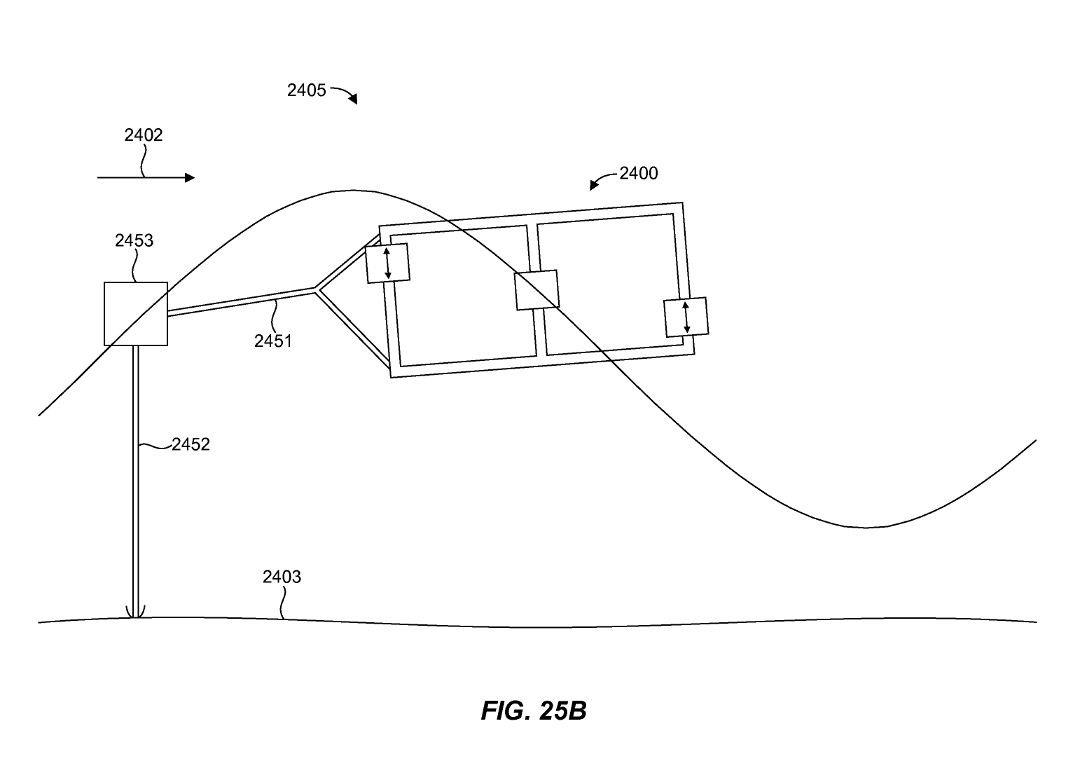

The tether configuration illustrated in FIGS. 25A and 25B can also facilitate alignment of the tether 2440 and the array of buoys 2400 with the direction of waves (i.e. currents) and/or wind. For example, as shown in the top view of the system 2405 in FIG. 26A, due to the anchoring location of the system being substantially below the lateral support buoy 2453, wind/waves in direction 2402a can orient the system 2405 such that the tether 2440 and the array of buoys 2400 are aligned with the wind/waves. As the wind/waves change to direction 2402b, as shown in FIG. 26B, the system 2405 can pivot about the anchoring point located below the lateral support buoy 2453 such that orientation of the system can align with the wind/wave direction 2402b.

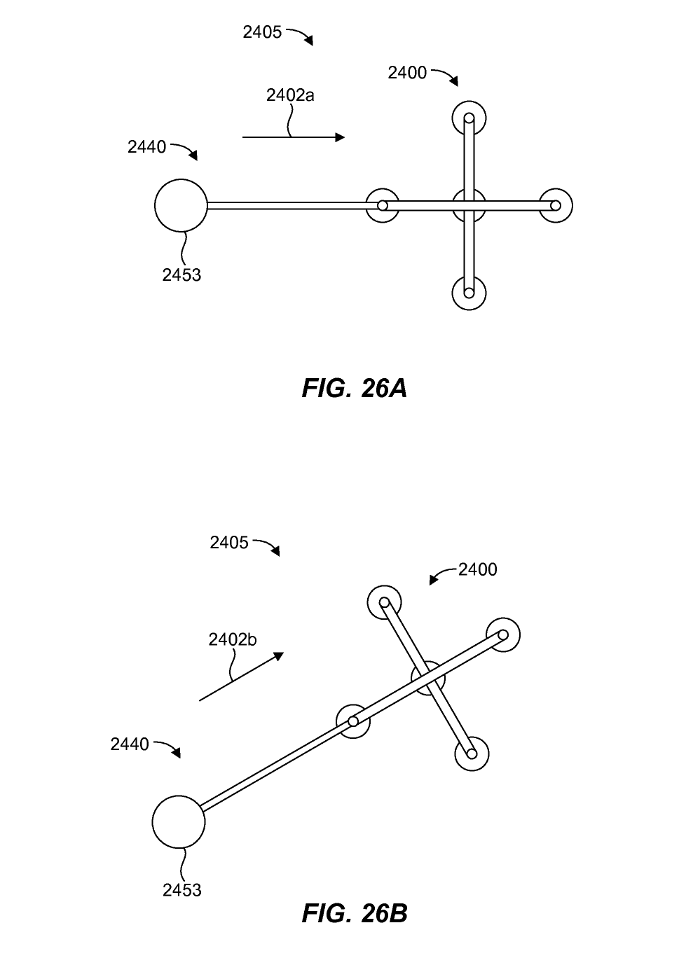

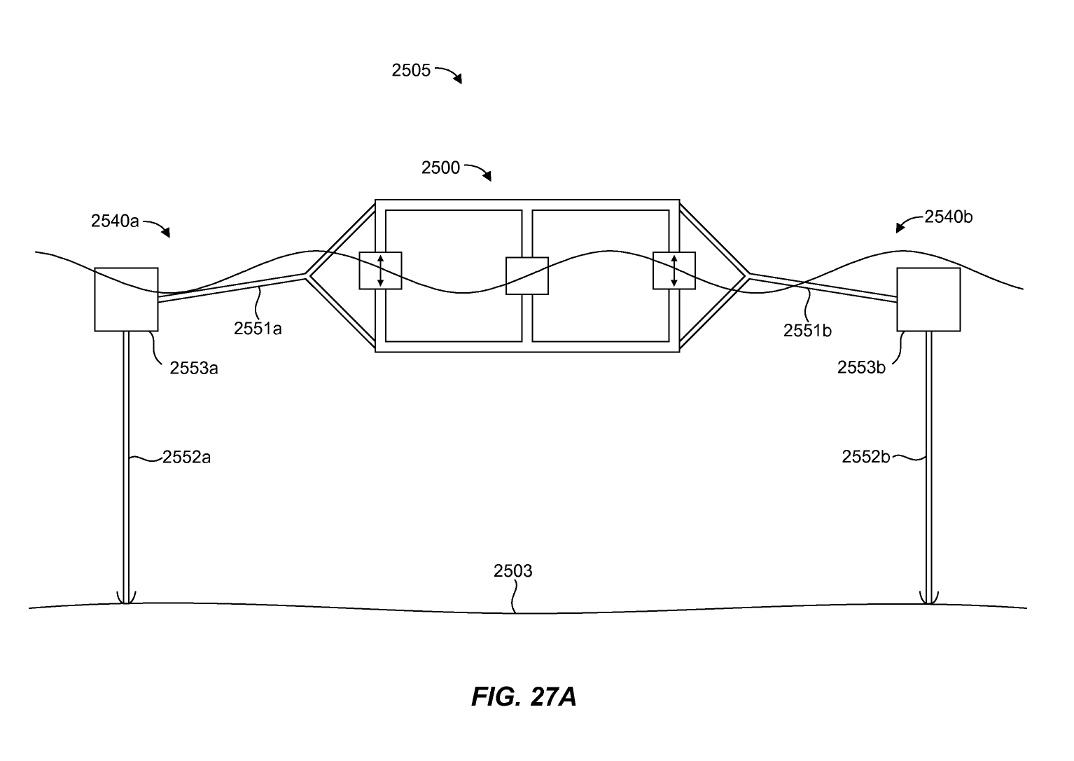

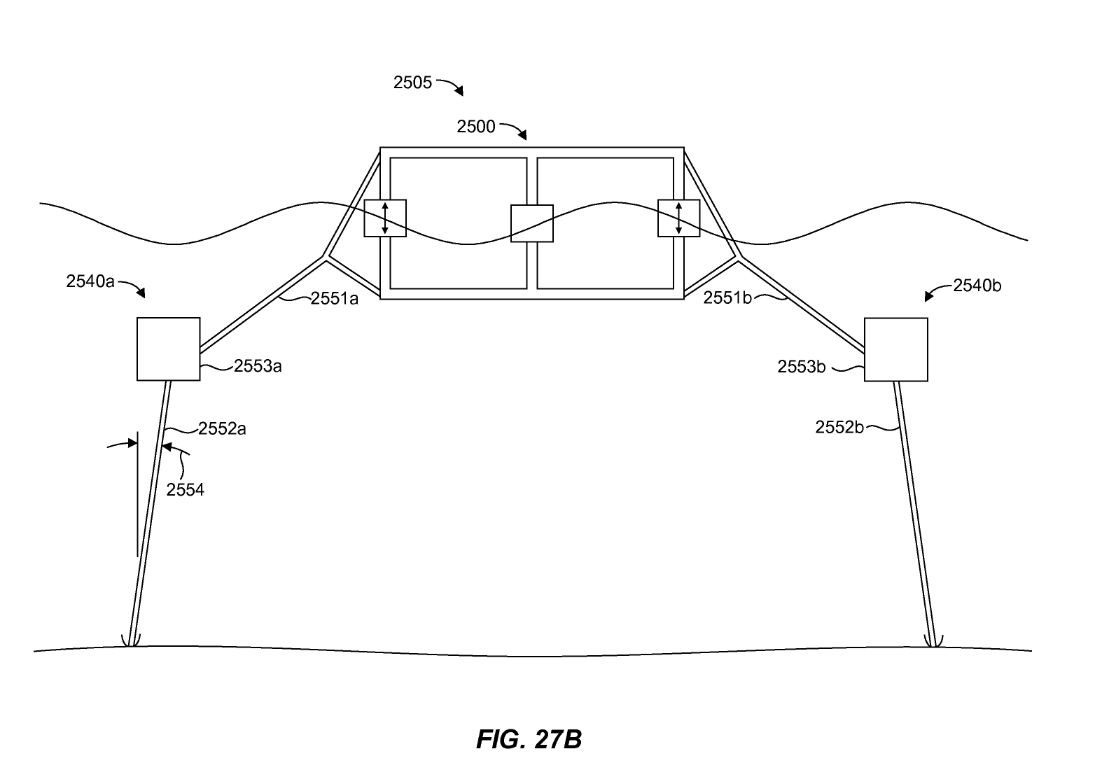

FIG. 27A illustrates a system 2505 for obtaining energy from surface waves in accordance with yet another example of the present disclosure. As with other examples described herein, the system 2505 can include an array of buoys 2500 and a buoyant tether 2540a coupled to the array of buoys. In this case, another buoyant tether 2540b can also be coupled to the array of buoys to provide additional stability when coupling to an object 2503, such as an ocean floor. The buoyant tethers 2540a, 2540b can be of similar configuration, having lateral tether portions 2551a, 2551b coupled to the array of buoys, vertical tether portions 2552a, 2552b to attach to the ocean floor, and lateral support buoys 2553a, 2553b coupled between the second lateral tether portions and the second vertical tether portions. As shown in the figure, the buoyant tethers 2540a, 2540b are coupled to the array of buoys about opposite sides, although the buoyant tethers can be in any suitable relative position when coupled to the array of buoys.

In one aspect, FIG. 27A can represent the system 2505 when the ocean is at low tide. In this case, the lateral support buoys 2553a, 2553b can be just under the water level with the vertical tether portions 2552a, 2552b in a vertical orientation. FIG. 27B can represent the system 2505 when the ocean is at high tide. In this case, the lateral support buoys 2553a, 2553b can lean in toward the array of buoys 2500 changing the orientation of the vertical tether portions 2552a, 2552b from vertical (FIG. 27A) to an angle 2554 off of vertical (FIG. 27B) by keeping the tethers 2540a, 2540b under tension and reducing or eliminating slack that may exist in the tethers as wave conditions change from low to high tide. A length of the lateral tether portions 2551a, 2551b can be increased to improve performance.

FIG. 27C illustrates the system 2505 when subjected to an extreme wave. As with the system 2405 illustrated in FIG. 25B, the lateral buoyant tether 2540a of the system 2505 can be configured to hold the horizontal position of the array of buoys 2500 and counteract the surfing force acting on the array of buoys caused by the wave propagating in direction 2502. In this case, the buoyant tether 2540b can go slack, or a tensioner can reduce the length of tether to eliminate the slack, while the wave passes the tether 2540b and the array of buoys is being supported by the tether 2540a. The vertical tether portion 2552b can float if configured with buoyant devices or if it has built in buoyancy. In one aspect, the buoyant tethers 2540a, 2540b can provide support for the array of buoys 2500 against waves propagating in different directions.

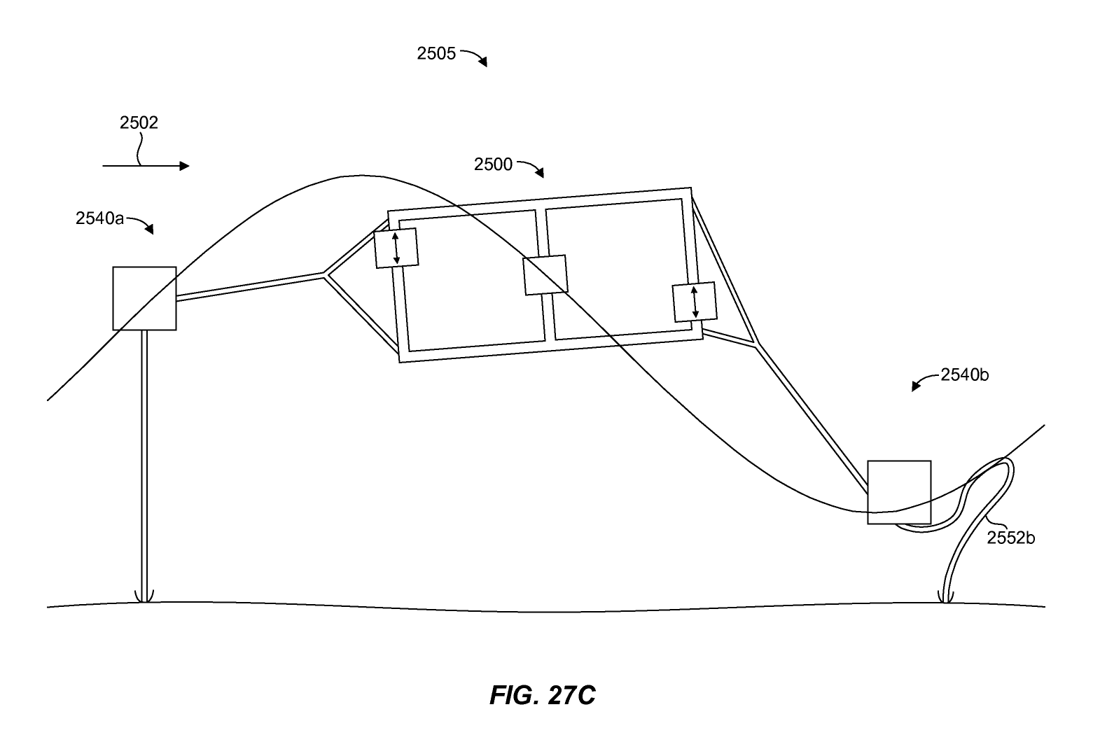

FIG. 28 illustrates a system 2605 for obtaining energy from surface waves in accordance with still another example of the present disclosure. In this case, the system 2605 includes multiple arrays of buoys 2600a-e coupled to one another with lateral tethers 2655a-d in a linear arrangement. The lateral tethers 2655a-d can be attached to the array of buoys at interior or center members of the frameworks and/or to outside members of the frameworks. One or more buoyant tethers can be coupled to the arrays of buoys. For example, buoyant tethers 2640a, 2640b can be coupled to the arrays of buoys 2600a, 2600e, respectively, at opposite ends of the linear arrangement to provide support for the multiple arrays of buoys 2600a-e against a wave, such as a wave propagating in direction 2602. In one aspect, the buoyant tethers 2640a, 2640b can provide support for the multiple arrays of buoys 2600a-e against waves propagating in different directions.

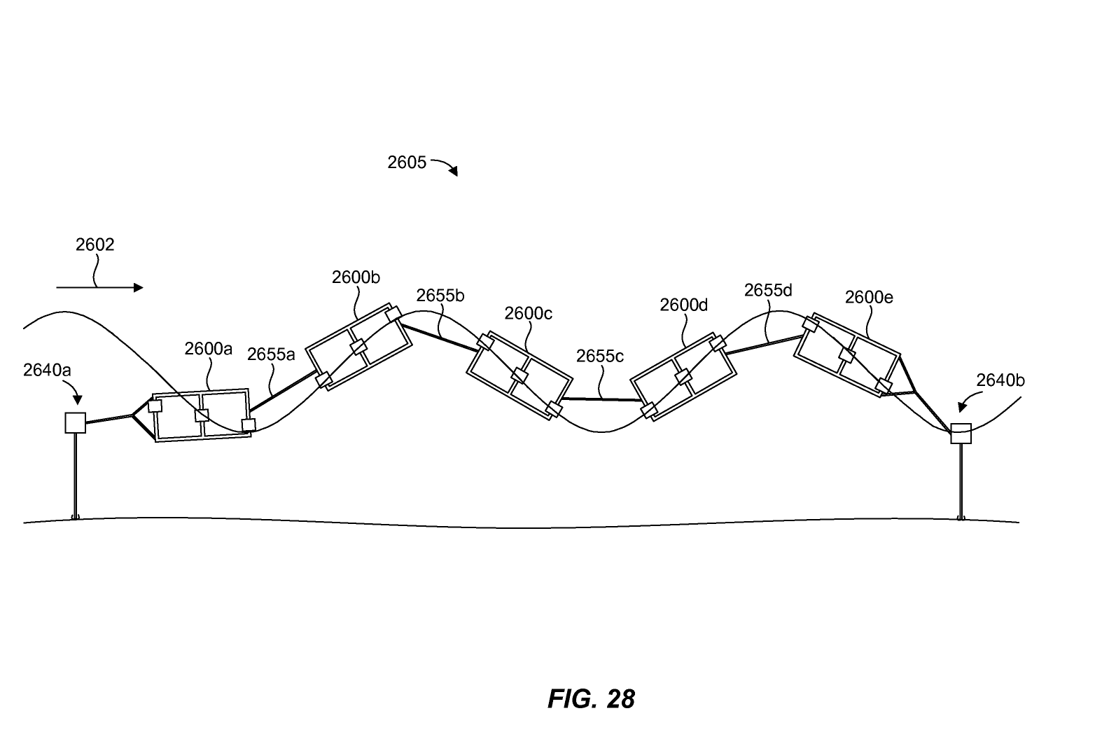

FIGS. 29A and 29B illustrate a system 2705 for obtaining energy from surface waves in accordance with a further example of the present disclosure. The system 2705 includes multiple arrays of buoys 2700a-c coupled to one another with lateral tethers 2755a-b in a linear or end-to-end arrangement. Buoyant tethers 2740a, 2740b can be coupled to the arrays of buoys 2700a, 2700c, respectively, at opposite ends of the linear or end-to-end arrangement to provide support for the multiple arrays of buoys 2700a-c against a wave, such as a wave propagating in direction 2702a as shown in FIG. 29A. In one aspect, the buoyant tethers 2740a, 2740b can be configured to facilitate orientation or alignment of the multiple arrays of buoys 2700a-c with the wind and incoming wave direction. For example, the buoyant tether 2740b can be located downwind from the buoyant tether 2740a. The downwind buoyant tether 2740b (e.g., a vertical tether portion) can be provided with more length or slack than the buoyant tether 2740b (e.g., the vertical tether portion) located upwind. The additional length or slack of the downwind buoyant tether or vertical tether portion can facilitate movement of the multiple arrays of buoys due to wind and wave movement that can allow the multiple arrays of buoys to realign or reorient with changing wind and wave directions. As shown in FIG. 29B, the wind/waves can change to direction 2702b, thus causing the arrays of buoys to move in direction 2706 away from the original orientation axis 2707 until the slack in the buoyant tether 2740b, which may come from the vertical tether portion 2752b, is removed. The arrays of buoys and buoyant tethers can then assume a generally arcuate shape between the anchor points on the ocean floor according to the drag forces on the various components of the system from the wind/waves.

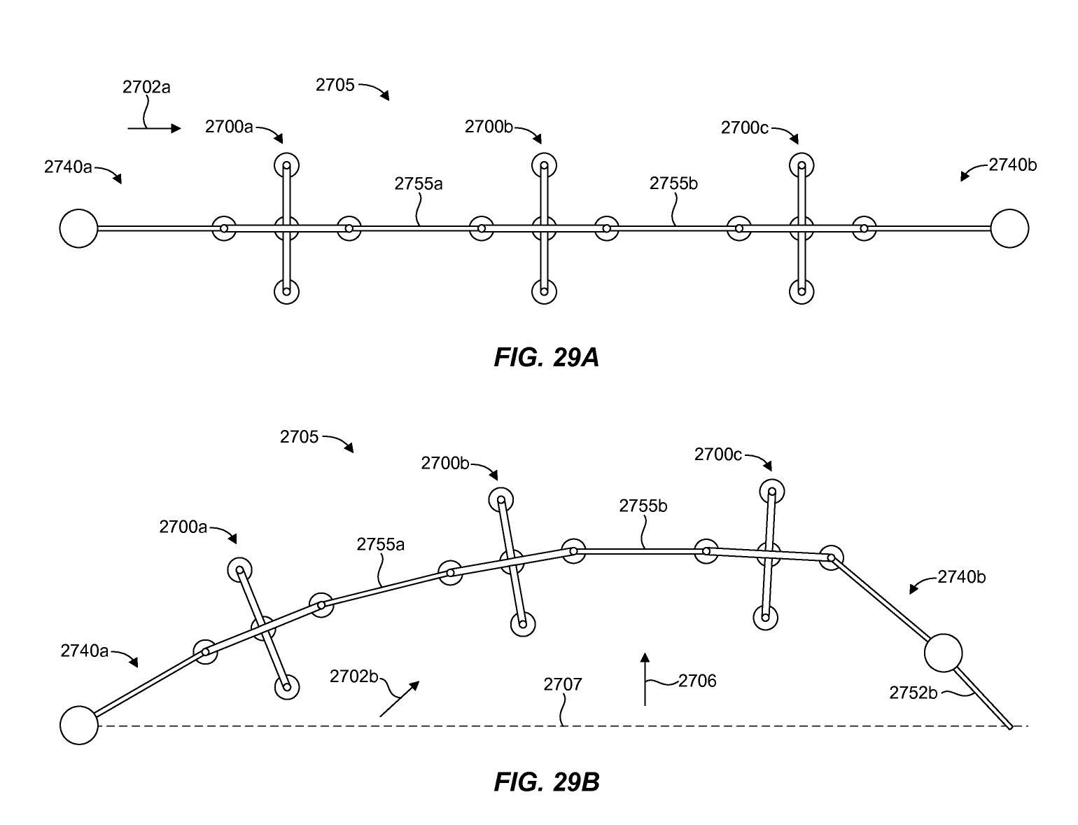

FIG. 30 illustrates a system 2805 for obtaining energy from surface waves in accordance with another example of the present disclosure. The system 2805 includes multiple arrays of buoys 2800a-f coupled to one another with lateral tethers 2755a-g in a grid arrangement or configuration. Buoyant tethers 2740a-j can be coupled to the arrays of buoys about a perimeter of the grid arrangement. In particular, the buoyant tethers 2840a-c are disposed opposite the buoyant tethers 2840d-f, respectively, and the buoyant tethers 2840g-h are disposed opposite the buoyant tethers 2840i-j, respectively. In this configuration, lateral tether portions 2851a-f can be oriented substantially orthogonal to lateral tether portions 2851g-j, which can provide support for the arrays of buoys in multiple directions.

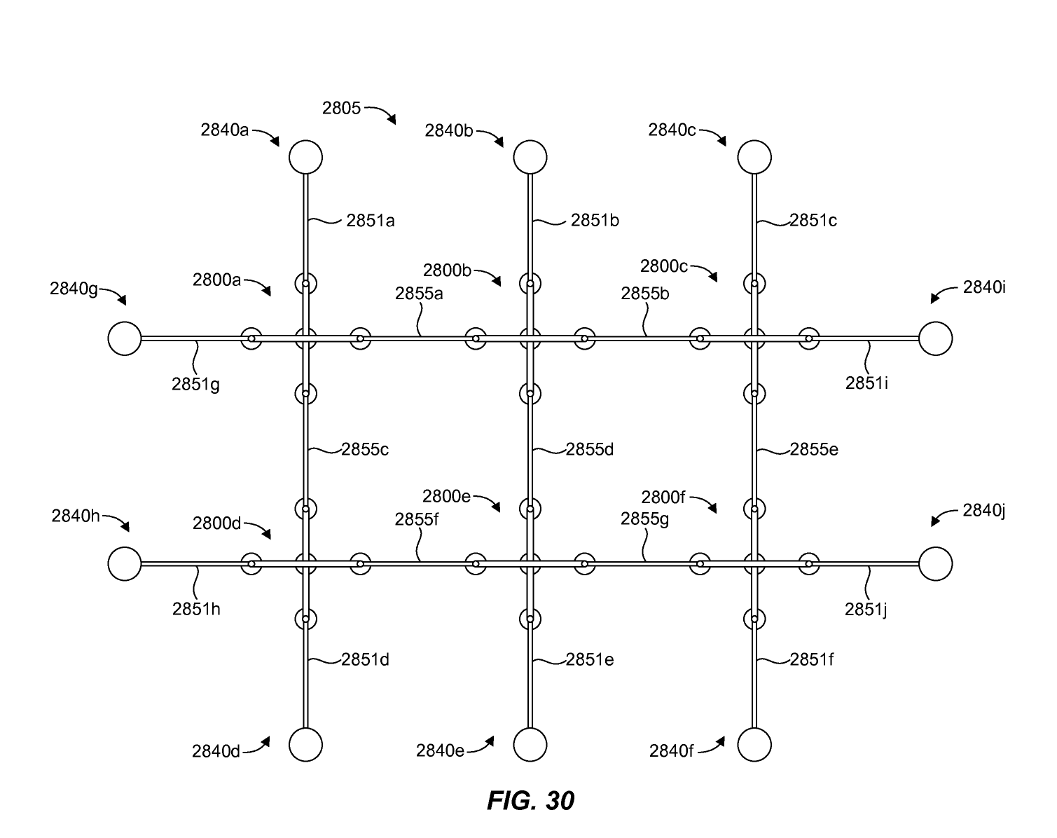

FIG. 31 illustrates a system 2905 for obtaining energy from surface waves in accordance with yet another example of the present disclosure. As with other examples described herein, the system 2905 can include an array of buoys 2900 and a buoyant tether 2940 coupled to the array of buoys. In this case, the buoyant tether is shown illustrated as if coupled to an object, such as a boat or other such object that is movable through water to tow the array of buoys. It should be recognized that any suitable buoyant tether may be utilized as described herein. In some embodiments, the tether may not be buoyant, but may be a standard tow line.

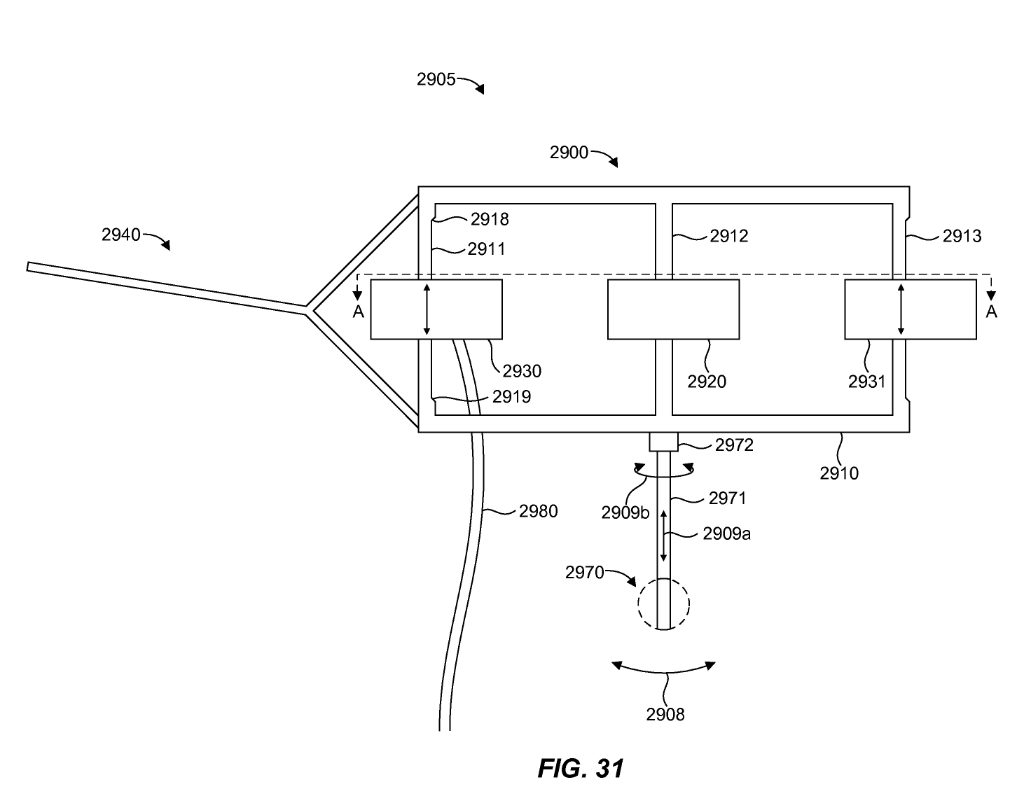

In one aspect, one or more of a base buoy 2920 and movable buoys 2930, 2931 of the array of buoys 2900 can comprise a hydrodynamic surface to reduce drag as water passes around the buoy, as shown in a top cross-sectional view A-A in FIG. 32. A hydrodynamic surface can comprise bow portion 2932 at a leading end of the buoy and a stern portion 2933 at a trailing end of the buoy. A length of the bow portion and the stern portion can be different (i.e., short bow portion and long stern portion) to facilitate orienting the array of buoys. In one aspect, all buoys of the array of buoys can include such hydrodynamic surface features and can be oriented in the same direction, as shown in FIG. 32, which can reduce or minimize the forces from the surf or breaking waves on the array of buoys.

With further reference to FIG. 31, the array of buoys 2900 can also include a ballast portion 2970 operable with the base buoy 2920 to move in a “pendulum motion” in direction 2908 in response to a wave in the body of water. The ballast portion can provide stability (e.g., rotational stability) for the array of buoys such that the array of buoys tends to restore itself to an equilibrium position after a small angular displacement. As illustrated in the figure, the ballast portion 2970 can be disposed below the base buoy 2920, such that the base buoy is substantially maintained above the ballast portion. Some examples of ballast portions can be found in FIGS. 5A-8 and discussed above. Including the ballast portion 2970 with the array of buoys can enable the array of buoys to remain in, or return to, a desired operational orientation even when subjected to forces (e.g., waves) tending to tip or rotationally displace the array of buoys. The ballast portion 2970 can therefore be utilized in any array of buoys to maintain wave energy harvesting functionality throughout a variety of adverse conditions. Such a design element can be utilized to control “wiggle” of the array of buoys by providing enough negative stability so that the array of buoys will move for effective operation in harvesting wave energy, but with enough positive stability so that the array of buoys will right itself and maintain a desired functional orientation.

An extension member 2971 can be coupled to the base buoy 2920 (e.g., via the framework 2910) and the ballast portion 2970 to suspend the ballast portion below the base buoy. In one aspect, the extension member can be extendable and retractable in direction 2909a to vary a distance between the ballast portion and the base buoy, thus varying or controlling the stability of the array of buoys. For example, moving the ballast portion upward can reduce stability and provide for a faster response and moving the ballast portion downward can increase stability and provide for a slower response.

In one aspect, the ballast portion 2970 can be configured as a rudder to facilitate turning or guiding the array of buoys 2900 in the water, such as into the direction of the waves. For example, the ballast portion can be rotatable in direction 2909b, such as by a motor 2972, to act as a rudder and guide or steer the array of buoys. The ability to steer the array of buoys can be useful when the array of buoys is being towed by a ship, as the array of buoys can turn with the ship for more for more effective towing and avoidance of obstacles.

In one aspect, vertical members 2911, 2913 of the framework 2910 and the movable buoys 2930, 2931 can be configured to maintain an orientation of the movable buoys relative to the vertical members. For example, as shown in FIG. 32, the vertical members and the movable buoys can have an interfacing geometry 2934 that resists rotation of the movable buoys about the vertical members, such as due to a wave. As illustrated, such a geometrical relationship is provided by a generally circular cross-section with a flat portion 2935 on one side. The flat portion can be ground or machined into a structure having a circular cross-section. In this case, the flat portions are located on back sides of the vertical members or, in other words, on sides opposite the direction of travel as identified by the location of the bow (front) and stern (rear) portions 2932, 2933 of the buoys. Such a configuration can provide low friction for vertical movement of the buoys while resisting rotation of the buoys due to lateral forces that may occur due to waves. It should be recognized that any suitable interfacing geometrical configuration can be utilized, such as a rectangular cross-section. The base buoy 2920 can be fixed relative to the vertical member 2912 by a fastener 2936 or other suitable device. The interfacing geometry can transition to a different shape at transition features 2918, 2919. Such transition features can serve as stops to vertical movement of the movable buoys along the vertical members. In one aspect, the transition features can be configured to bind or wedge the movable buoys when enough force is applied. This can prevent additional movement or operation of the movable buoys in the event of a severe storm or wave event until service or maintenance can be provided, which can minimize the risk of damage to the array of buoys in extreme conditions.

Preventing rotation of the movable buoys 2930, 2931 about the vertical members 2911, 2913 can be particularly beneficial when the movable buoys are configured with hydrodynamic surfaces, such as the bow and stern portions 2932, 2933. The absence of such relative rotation can also be beneficial, even when the movable buoys lack such hydrodynamic surfaces, to prevent tangling of a utility or feed line 2980, which may be coupled to the array of buoys 2900, due to spinning or rotating movable buoys. For example, utility or feed lines can be used to deliver power from a power generator associated with the movable buoys to a transmission line, which may be located underwater. Examples of such utility or feed lines are discussed herein.

In one embodiment, a method for obtaining energy from a wave in a body of water in accordance with the principles herein is disclosed. The method can include obtaining an array of buoys including a framework having a plurality of vertical members, a base buoy coupled to the framework to support the framework in a body of water and maintain the vertical members in a vertical orientation, a plurality of movable buoys, wherein each of the plurality of movable buoys is movably disposed about a different one of the plurality of vertical members and configured to move relative to the respective vertical members and the base buoy in response to a wave in the body of water, and an energy conversion device operable with each of the plurality of movable buoys to generate power from movement of the movable buoys relative to the vertical members. The method can also include coupling a buoyant tether to the array of buoys. The method can further include disposing the array of buoys in the body of water. Additionally, the method can include securing the array of buoys to an object.

In one aspect of the method, the buoyant tether can comprise a lateral tether portion to couple to the array of buoys, a vertical tether portion to attach to an ocean floor, and a lateral support buoy coupled between the lateral tether portion and the vertical tether portion. It is noted that no specific order is required in this method, though generally in one embodiment, these method steps can be carried out sequentially.

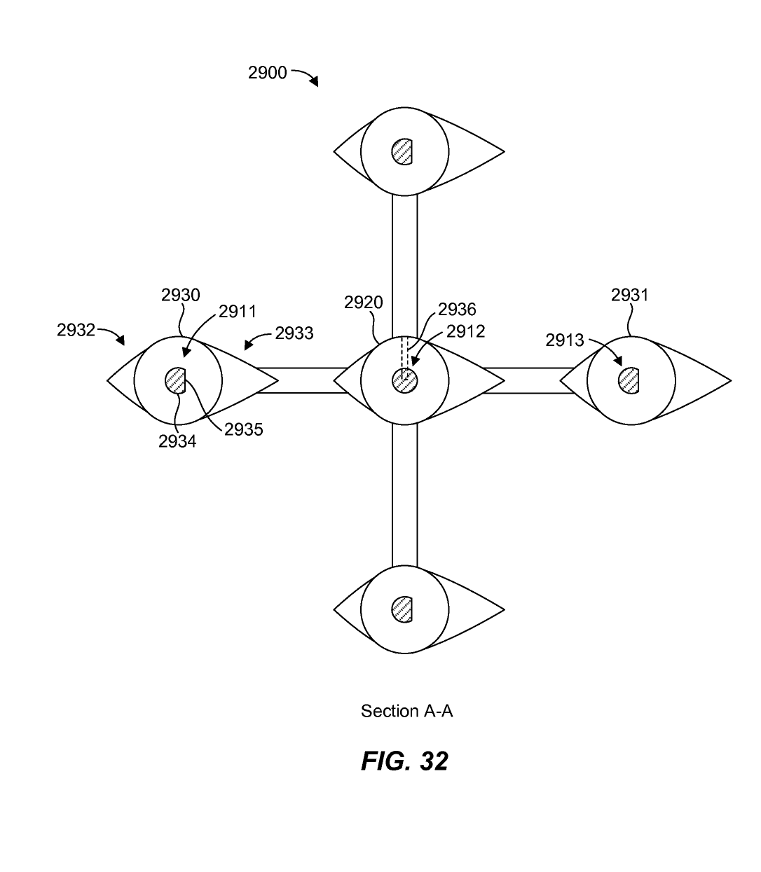

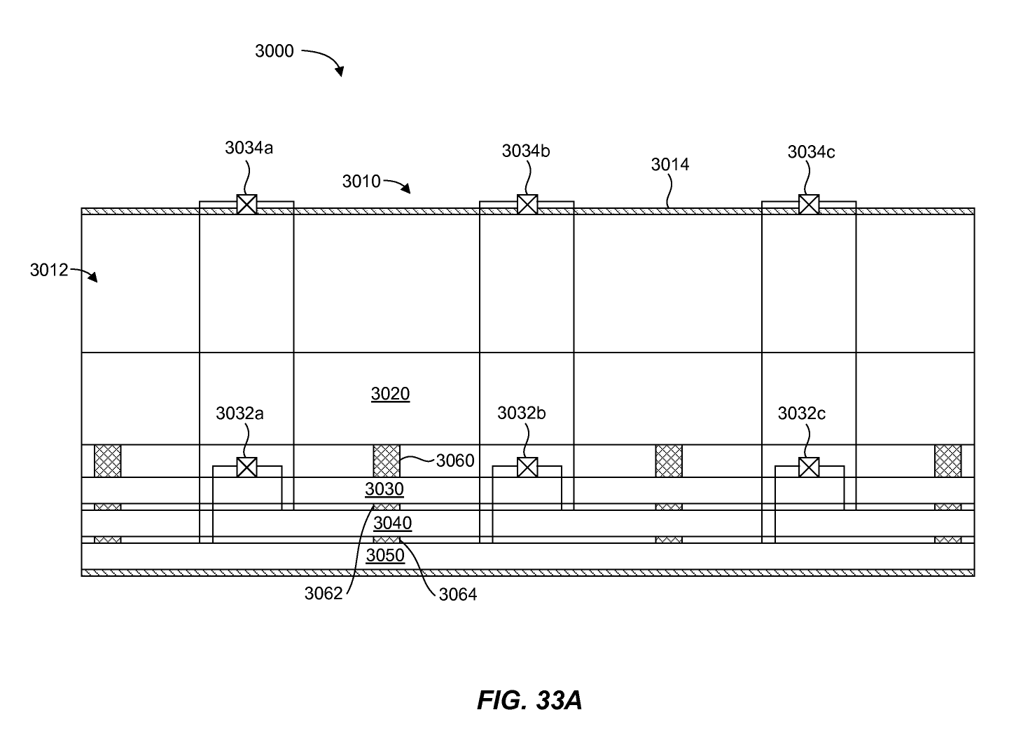

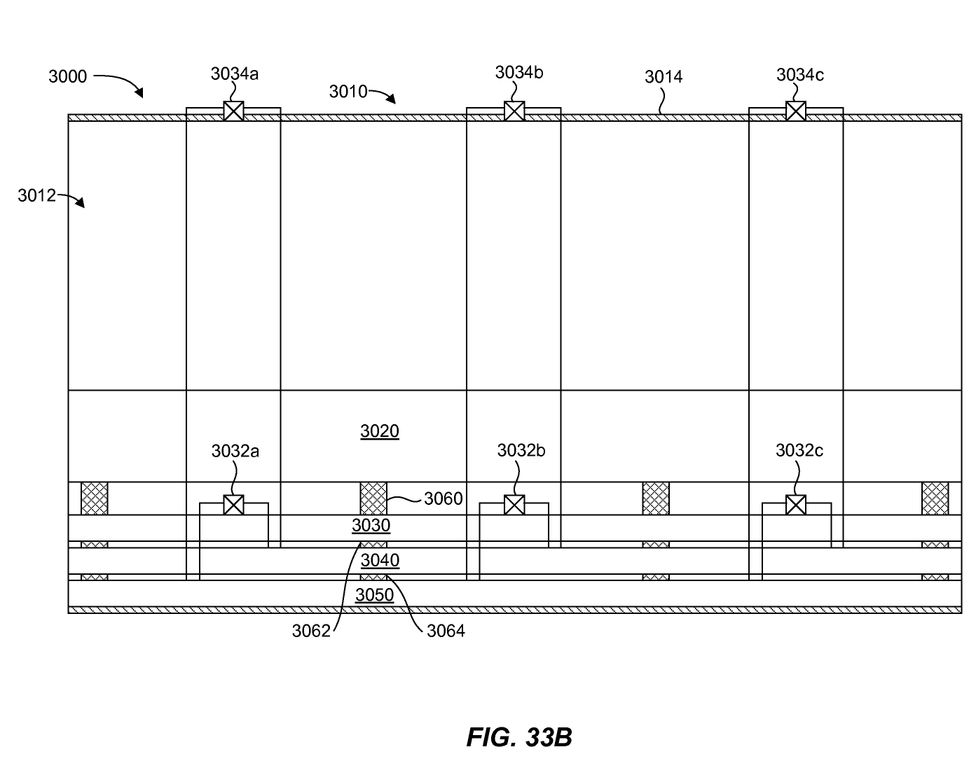

FIGS. 33A-33C illustrate an underwater utility line 3000 in accordance with an example of the present disclosure. The underwater utility line 3000 can include an adjustably buoyant tube 3010 and a transmission line 3020 disposed in an interior 3012 of the adjustably buoyant tube. The transmission line can transfer energy from a power generator (such as a wave power generator) to a desired destination location (such as a ship or a power grid). Accordingly, the transmission line can be adapted to carry water (i.e., such transmission line 3020 is hollow and watertight) and/or configured as an electrical conductor. The underwater utility line 3000 can also include a gas source 3030 (e.g., a gas supply line), and a controller 3040 to control the gas provided by the gas source to alter the buoyancy of the adjustably buoyant tube 3010 thereby causing the utility line 3000 to “float” or “sink” in a controllable manner to achieve a desired depth in a body of water. In general, the buoyancy of the adjustably buoyant tube 3010 can be controlled with any technology known in the art. In one aspect, the gas source 3030 can be fluidly coupled to the interior of the adjustably buoyant tube 3010 to provide gas to the interior of the tube.

In one aspect, the underwater utility line 3000 can include one or more gas injection valves 3032a-c in fluid communication with the gas source 3030. The underwater utility line 3000 can also include one or more gas expulsion valves 3034a-c associated with a wall 3014 of the adjustably buoyant tube 3010. The underwater utility line 3000 can further include a source of power, such as an electrical line 3050, which can be used to power the gas injection valves 3032a-c and/or the gas expulsion check valves 3034a-c. In one aspect, the controller 3040 can communicate with and control the gas injection valves 3032a-c and/or gas expulsion check valves 3034a-c. For example, the gas injection valves 3032a-c can selectively introduce gas into the adjustably buoyant tube 3010 and the gas expulsion valves 3034a-c can selectively evacuate gas from the adjustably buoyant tube 3010 to adjust the buoyancy of the tube. The controller 3040 can be in communication with the gas injection valves 3032a-c and/or the gas expulsion valves 3034a-c via a hardwired connection (shown) and/or wireless connection with a transmitter and a receiver to control the gas injection valves 3032a-c and the gas expulsion valves 3034a-c.

In one aspect, illustrated in FIGS. 33A-33C, the adjustably buoyant tube 3010 can be diametrically expandable by gas. Thus, buoyancy of the underwater utility line 3000 can be controlled by having the adjustably buoyant tube 3010 be constructed of any expandable material known in the art and increasing the pressure of the gas, preferably air, in the adjustably buoyant tube 3010 to expand the adjustably buoyant tube 3010 (FIG. 33B) and thereby increase the volume and buoyancy or decreasing the pressure of the gas in the adjustably buoyant tube 3010 to allow the volume of the adjustably buoyant tube 3010 to contract (FIG. 33C) and the buoyancy to decrease.

The gas injection valves 3032a-c, which are in fluid communication with the gas supply line 3030, can inject gas (e.g., air) into the adjustably buoyant tube 3010. The gas expulsion valves 3034a-c, which can be in the wall 3014 of the adjustably buoyant tube 3010 preferably near the top of the tube, can expel the gas from the adjustably buoyant tube 3010. The gas expulsion valves 3034a-c can be check valves allowing gas to escape from the adjustably buoyant tube 3010 but not permitting water to enter the adjustably buoyant tube 3010. It should be recognized that if the adjustably buoyant tube 3010 is of sufficiently short length, the gas can simply be introduced from one or more ends of the adjustably buoyant tube 3010. Similarly, if the adjustably buoyant tube 3010 is sufficiently short, the gas can simply be expelled from one or more ends of the adjustably buoyant tube 3010.

Although the gas source 3030, the controller 3040, and the electrical line 3050 are shown located within the adjustably buoyant tube 3010, it should be recognized that the gas supply line 3030, the controller 3040, and/or the electrical line 3050 can be located external to the adjustably buoyant tube 3010 but in communication with the interior of the adjustably buoyant tube 3010 or components within the adjustably buoyant tube 3010 as appropriate to perform as described herein.

In one aspect, the transmission line 3020 can be held by one or more supports 3060 spaced along the interior 3012 of the adjustably buoyant tube 3010, although it should also be recognized that the transmission line 3020 can simply rest inside the adjustably buoyant tube 3010. One or more supports 3062, 3064 can also be used to support the gas source 3030, the controller 3040, and/or the electrical line 3050.

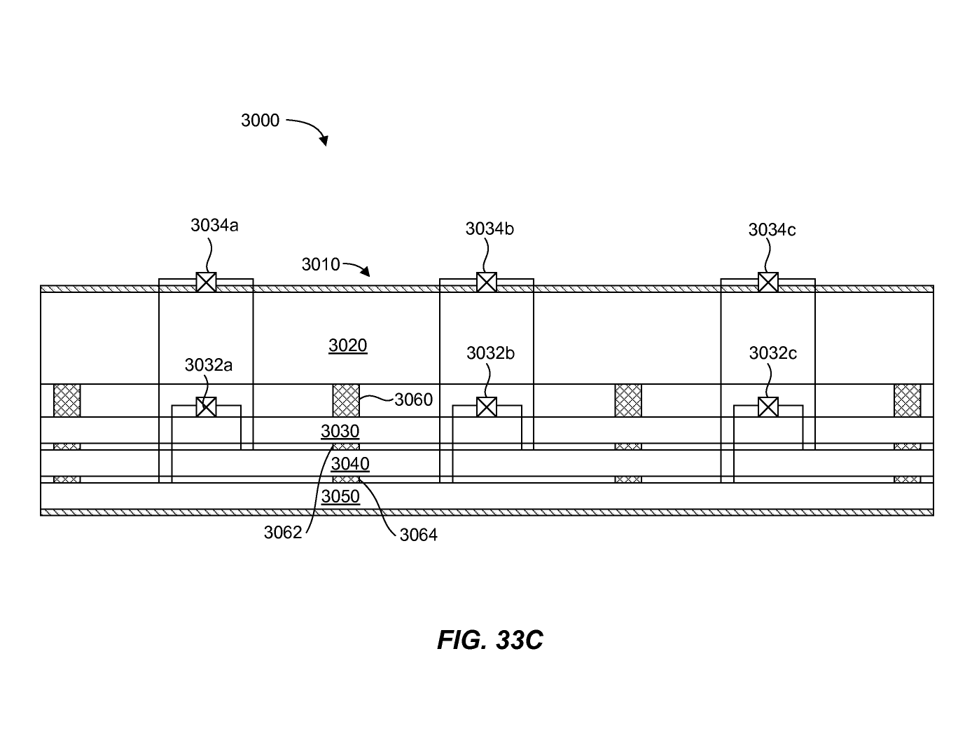

FIG. 34 illustrates an underwater utility line 3100 in accordance with another example of the present disclosure. As with the underwater utility line 3000 of FIGS. 33A-33C, the underwater utility line 3100 can include an adjustably buoyant tube 3110, a transmission line 3120, a gas source 3130, a controller 3140, one or more gas injection valves 3132a-c, one or more gas expulsion check valves 3134a-c, and an electrical line 3150 to power the gas injection valves 3132a-c and the gas expulsion check valves 3134a-c. In this case, the adjustably buoyant tube 3110 can be divided into compartments 3111a-c with one or more spacers 3166. If the adjustably buoyant tube 3110 is so divided, each such spacer 3166 can have one or more apertures (designated the “spacer apertures”) 3168a-d to allow the transmission line 3120, the gas source 3130, the controller 3140, and the electrical line 3150 to pass through the spacer 3166. The spacer 3166 can also serve as a support for the transmission line 3120, the gas source 3130, the controller 3140, and/or the electrical line 3150.

If the spacer 3166 is impermeable to the gas utilized, then one or more valves 3136 (i.e., gas transit valves) can be included between the compartments 3111a-c to allow the gas to pass through (or transit) such spacers 3166. Any technology known in the art can be utilized, such as using the electrical line 3150 and the controller 3140 to remotely open and close the valves 3136. In one aspect, the gas supply line 3130 can have gas injection valves 3132a-c located along the gas source 3130 at such distances that at least one gas injection valve 3132a-c can be placed between each set of adjacent supports 3166, as well as at least one gas expulsion valve 3134a-c. Utilizing compartments 3111a-c can enable the buoyancy to be different between different sets of adjacent spacers 3166, provided the transmission line 3120, the gas supply line 3130, the electrical line 3150, and the controller 3140 sealingly pass through each spacer aperture 3168a-d. In one aspect, the spacers 3166 can be permeable to the gas used. In this case, the gas source 3130 need not pass through the spacers and fewer than one gas injection valve and one gas expulsion valve per compartment can be utilized.

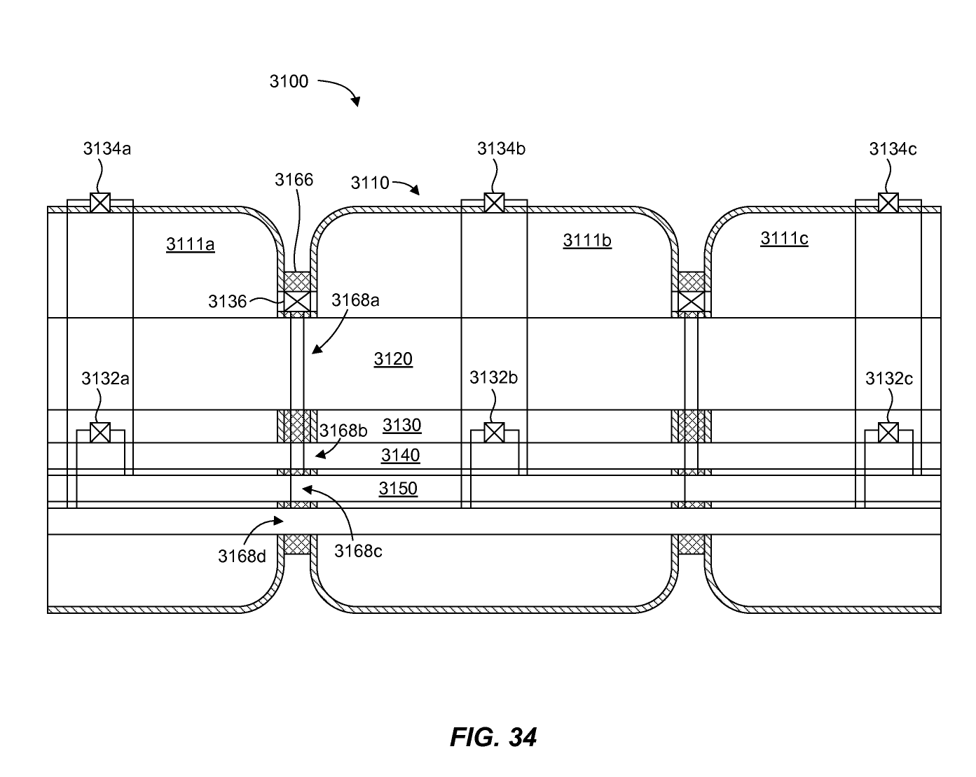

FIG. 35 illustrates an underwater utility line 3200 in accordance with yet another example of the present disclosure. The underwater utility line 3200 is similar to the underwater utility line 3000 of FIGS. 33A-33C in many respects. For example, the underwater utility line 3200 can include an adjustably buoyant tube 3110, a transmission line 3120, a gas source 3130, a controller 3140, one or more gas injection valves 3132a-c, one or more gas expulsion check valves 3134a-c, and an electrical line 3150 to power the gas injection valves 3132a-c and the gas expulsion check valves 3134a-c. In this case, the adjustably buoyant tube 3110 has a fixed diameter. Thus, the buoyancy of the underwater utility line 3200 can be controlled by flooding the adjustably buoyant tube 3210 and purging water from the adjustably buoyant tube 3210 utilizing technology similar to that used on a submarine to flood one or more ballast tanks with water and purge such tanks with air. Accordingly, the underwater utility line 3200 can include one or more flood ports 3238a-c associated with a wall 3214 (i.e., near a bottom) of the adjustably buoyant tube. When buoyancy is adjusted by flooding the adjustably buoyant tube 3210 and purging water therefrom, all the structure utilized above with gas and the expandable adjustably buoyant tube 3210 can be employed except that the tube 3210 is not “expandable,” i.e., a change in internal or external pressure could produce some change in the diameter of the adjustably buoyant tube 3210 but not to the degree that one of ordinary skill in the art would term the tube 3210 “expandable.”

Gas can be evacuated from the adjustably buoyant tube 3210 by operating the gas supply line 3230 in reverse and/or by allowing gas to escape from the adjustably buoyant tube 3210 via the gas expulsion check valves 3234a-c near the top of the adjustably buoyant tube 3210, with such gas expulsion check valves 3234a-c not permitting water to enter the adjustably buoyant tube 3210. When it is desired to decrease the buoyancy of the underwater utility line 3200, or of a compartment in the underwater utility line 3200, the flood ports 3238a-c can be opened to allow water to enter the adjustably buoyant tube 3210, and the gas supply line 3230 can be operated to withdraw gas from the adjustably buoyant tube 3210 and/or the gas expulsion check valves 3234a-c can be opened to allow gas to escape from the adjustably buoyant tube 3210 if the gas pressure is sufficiently high. When it is desired to increase the buoyancy of the underwater utility line 3200, or of a compartment in the underwater utility line 3200, the gas supply line 3230 can be operated to introduce gas into the adjustably buoyant tube 3210 and the flood ports 3238a-c can be opened to allow the introduced gas to force water to exit the adjustably buoyant tube 3210 through such flood ports 3238a-c.

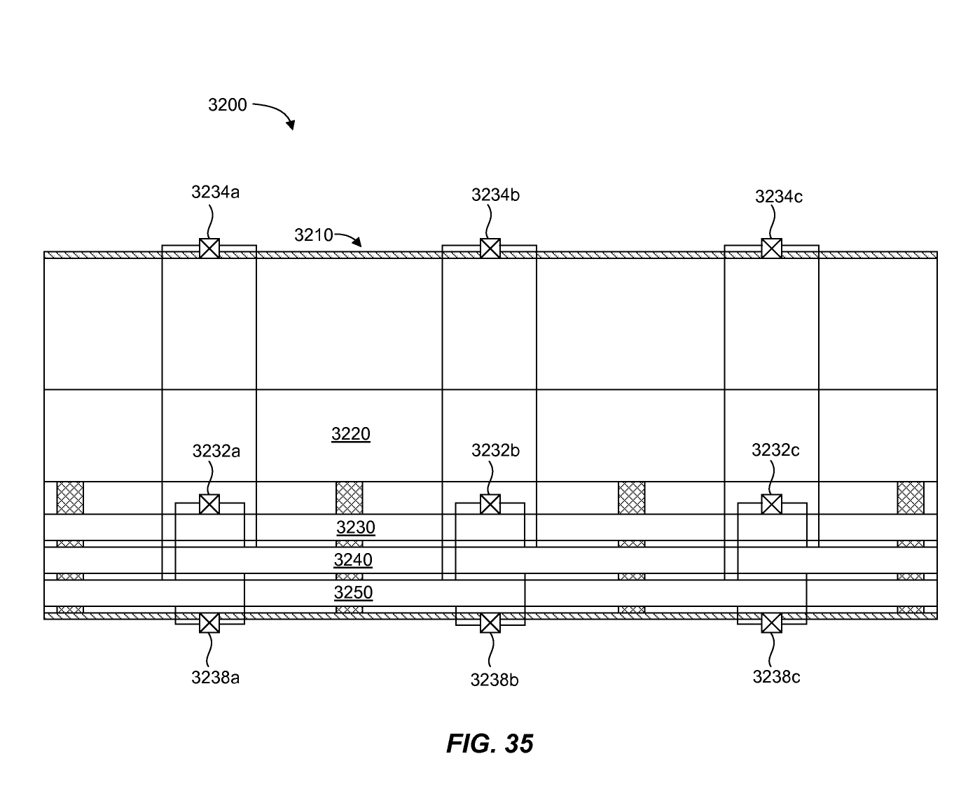

FIG. 36 illustrates an underwater utility line 3300 in accordance with still another example of the present disclosure. As with other underwater utility lines disclosed herein, the underwater utility line 3300 can include an adjustably buoyant tube 3310, a transmission line 3320, a gas source 3330, a controller 3340, and an electrical line 3350. In this case, the underwater utility line 3300 includes one or more buoyancy compensators 3370a-c in fluid communication with the gas source 3330 to alter the buoyancy of the underwater utility line 3300. The buoyancy compensators 3370a-c can each include a bladder that can be filled with gas from the gas source 3330. Buoyancy can be controlled by adjusting the volume of air in the bladder. Thus, the buoyancy of the underwater utility line 3300 can be adjusted utilizing technology used in SCUBA diving vest BC buoyancy compensators, i.e., one or more buoyancy compensators 3370a-c adapted using any technique known in the art for attachment of the buoyancy compensators to the adjustably buoyant tube 3310, rather than to a human being. The gas source 3330 is shown located outside the adjustably buoyant tube 3310 proximate the buoyancy compensators 3370a-c, although the gas source can be disposed in any suitable location. In some embodiments, the gas source may be a compressed gas container disposed within or otherwise associated with the buoyancy compensators. In this case, there may not be a need for a gas supply line.

The electrical line 3350 and the controller 3340 can be coupled to the buoyancy compensators 3370a-b via hardline connections to control the buoyancy with the buoyancy compensators 3370a-b. The electrical line 3350 and the controller 3340 can be located within or, optionally, on the exterior of the adjustably buoyant tube 3310. When the electrical line 3350 and the hard wire control line 3340 are within the adjustably buoyant tube, hard wire connections can sealingly pass through one or more apertures 3316, 3318, designated “wall apertures,” in the wall 3314 of the adjustably buoyant tube 3310 to connect to each of the one or more buoyancy compensators 3370a-b.

In one aspect, the controller 3340 can communicate with the buoyancy compensator 3370c utilizing a radio transmitter 3372 and a radio receiver 3374 to facilitate the control and operation of the buoyancy compensator 3370c. In this case, a wire 3376 can sealingly pass through a wall aperture to provide communication through the wall 3314 between the radio receiver 3374 and the buoyancy compensator 3370c. In another aspect, a battery 3378 can be utilized in lieu the electrical line 3350 to power the buoyancy compensator 3370c.

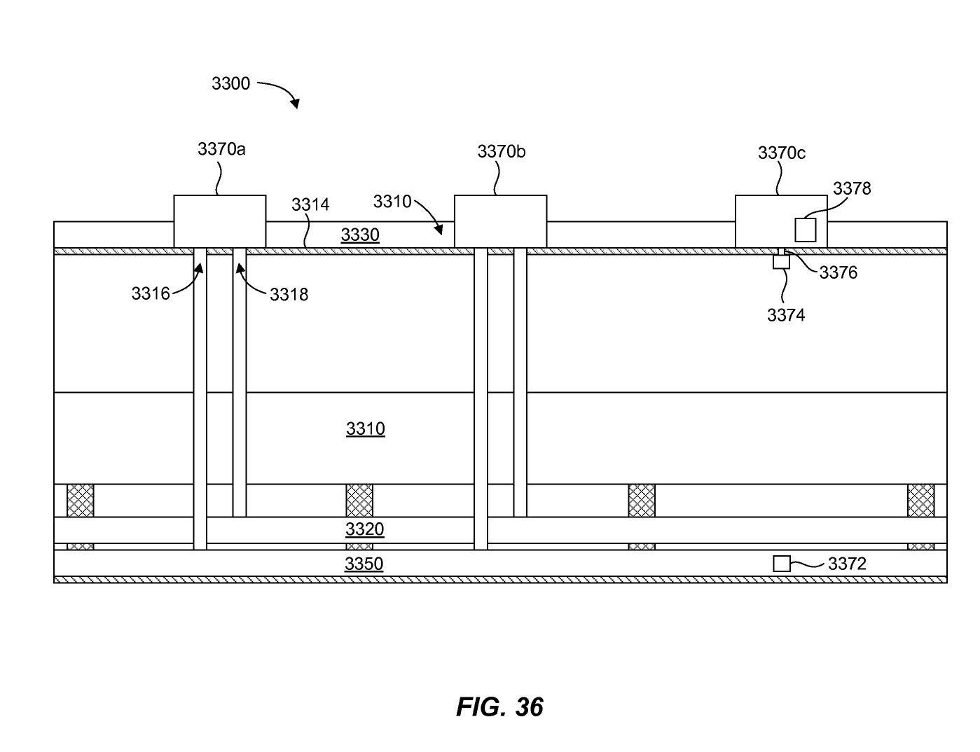

FIG. 37 illustrates an underwater utility line 3400 in accordance with a further example of the present disclosure. As with other underwater utility lines disclosed herein, the underwater utility line 3400 can include an adjustably buoyant tube 3410a, a transmission line 3420, a gas source 3430, a controller 3440, and an electrical line 3450. The underwater utility line 3400 can also include one or more gas injection valves 3432a-c, one or more gas expulsion check valves 3434a-c, and one or more flood ports 3438a-c. In this case, the underwater utility line 3400 can include a second adjustably buoyant tube 3410b disposed within the adjustably buoyant tube 3410a. For example, the adjustably buoyant tube 3410a can be concentrically located around the adjustably buoyant tube 3410b. This configuration can be advantageous if it is desired to keep components of the underwater utility line 3400 dry. For example, in one aspect, the transmission line 3420 can be disposed within the adjustably buoyant tube 3410b to keep the transmission line dry. In one aspect, the gas source 3430 can be fluidly coupled to a space 3413 between the outer adjustably buoyant tube 3410a and the inner adjustably buoyant tube 3410b, which are referred to collectively as the “adjustably buoyant tubes” or the “combined adjustably buoyant tube” 3410. Thus, the gas injection valves 3432a-c can selectively introduce gas into the space 3413, the gas expulsion valves 3434a-c can selectively evacuate gas from the space 3413, and the flood ports 3438a-c can selectively introduce water into the space 3413 to adjust the buoyancy of the tubes. In other words, the exchange of gas and water can occur only within the space 3413 between the adjustably buoyant tubes 3410a, 3410b, as occurs in the ballast tank of a submarine. The gas supply line 3430 can therefore be in fluid communication with the space 3413 between the outer adjustably buoyant tube 3410a and the inner adjustably buoyant tube 3410b, and the gas expulsion valves 3434a-c and the flood ports 3438a-c can be associated with the wall of the outer adjustably buoyant tube 3410a.

In one aspect, the adjustably buoyant tube 3410 can be divided into compartments 3411a-c with one or more spacers 3466 having one or more valves 3436, 3437 (i.e., fluid transit valves) included between the compartments 3411a-c to allow fluid (water or gas as the case may be) to pass through (or transit) such spacers 3466. When compartments are employed, such compartments can permit different sections of the combined adjustably buoyant tube 3410 to have different buoyancy.

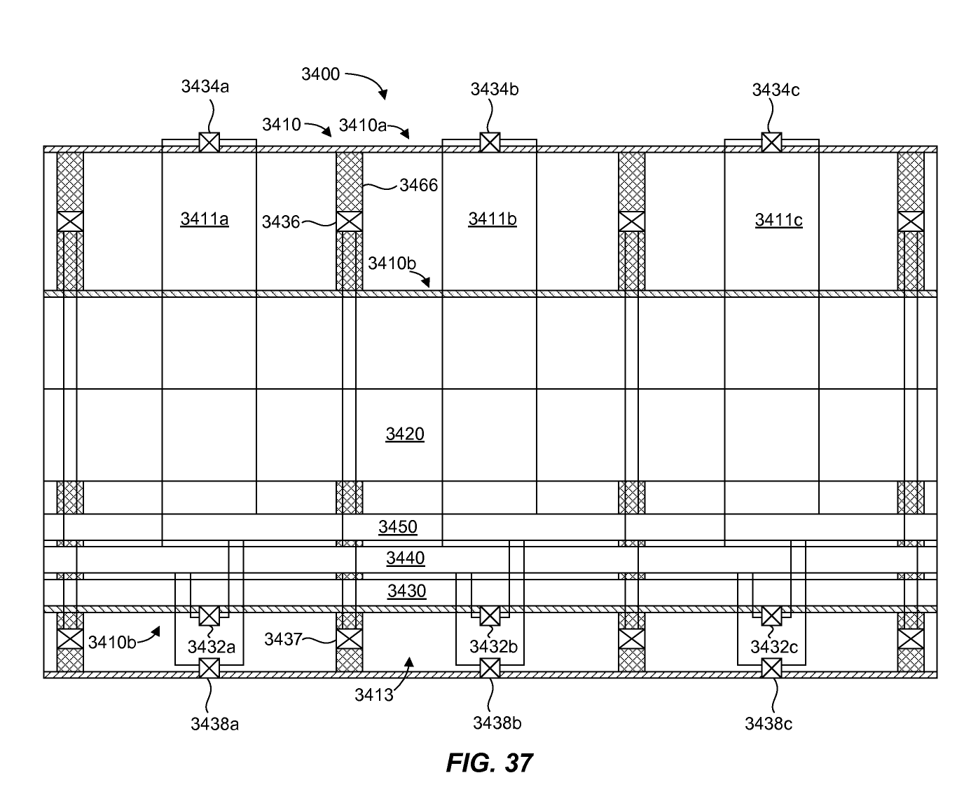

FIG. 38 illustrates an underwater utility system 3501 in accordance with an example of the present disclosure. The system 3501 can comprise an underwater utility line 3500 such as is disclosed hereinabove. For example, the under water utility line 3500 can include an adjustably buoyant tube, a transmission line within an interior of the adjustably buoyant tube, and a controller to control the buoyancy of the adjustably buoyant tube as described hereinabove. In one aspect, the underwater utility line may not be adjustably buoyant. The system 3501 can also include one or more buoys 3504 coupled to the underwater utility line 3500, such as via a tether 3506. The buoy 3504 can have a computer 3580, a global positioning system receiver 3582 in communication with the computer 3580 in order to determine the exact position of the underwater utility line 3500, and a sonar unit 3584. The drive device 3586, the computer 3580, the global position system receiver 3582, and/or the sonar unit 3584 can be connected to a source of power, which may be the electrical line associated with the underwater utility line 3500.

The tether 3506 between the buoy 3504 and the underwater utility line 3500 can be a cable, a rigid rod (e.g., fixed length or telescoping), or any other suitable tether configuration or structure. The electrical line of the underwater utility line 3500 may be coupled to the electronic components via an electrical coupling 3585 attached to or associated with the tether 3506. If the electrical line is inside the underwater utility line 3500, the electrical coupling 3585 can therefore sealingly pass through a wall aperture in the underwater utility line 3500. If the tether 3506 is a rigid rod, the attachment of the tether 3506 to the buoy 3504 and/or the underwater utility line 3500 can be rotatable about the pitch axis of the end of the tether 3506 making such connection. In one aspect, the attachment may also be rotatable about the yaw axis of the end of the tether making such connection. Such rotational ability facilitates movement of the buoy 3504 in relation to the underwater utility line 3500 when the depth of the underwater utility line 3500 is changed.

The system 3501 can also include a drive device 3586, such as a thruster, which may be associated with or attached to the underwater utility line 3500. The computer 3580 can be in communication with the drive device 3586 to maintain a desired position of the adjustably buoyant tube 3500. The drive device 3586 can be rotatable and can receive gas from the gas supply line, pressurized water from the transmission line, and/or electricity from the electrical line either to pump water surrounding the drive device 3586 or to operate a simple propeller that is known in the art to move the underwater utility line 3500. When buoyancy compensators are utilized, only the versions of the drive device 3586 that employ water may be practical since there may be no gas supply line in some embodiments.

If desired, the drive device 3586 can also be utilized for initial installation of the underwater utility line 3500. The buoy 3504 can also include one or more traditional warning lights known in the art to mark the location of the underwater utility line 3500 and thereby alert fishing boats not to drag fishing lines or nets into the underwater utility line. In one aspect, the underwater utility line 3500 can be submerged to a sufficient depth to allow ocean traffic to travel overhead without danger of collision with the underwater utility line 3500. It will, however, be apparent to one of ordinary skill in the art that the underwater utility line 3500 can be raised to the surface or a shallow depth in order to reduce the cost of performing maintenance or performing a repair action.

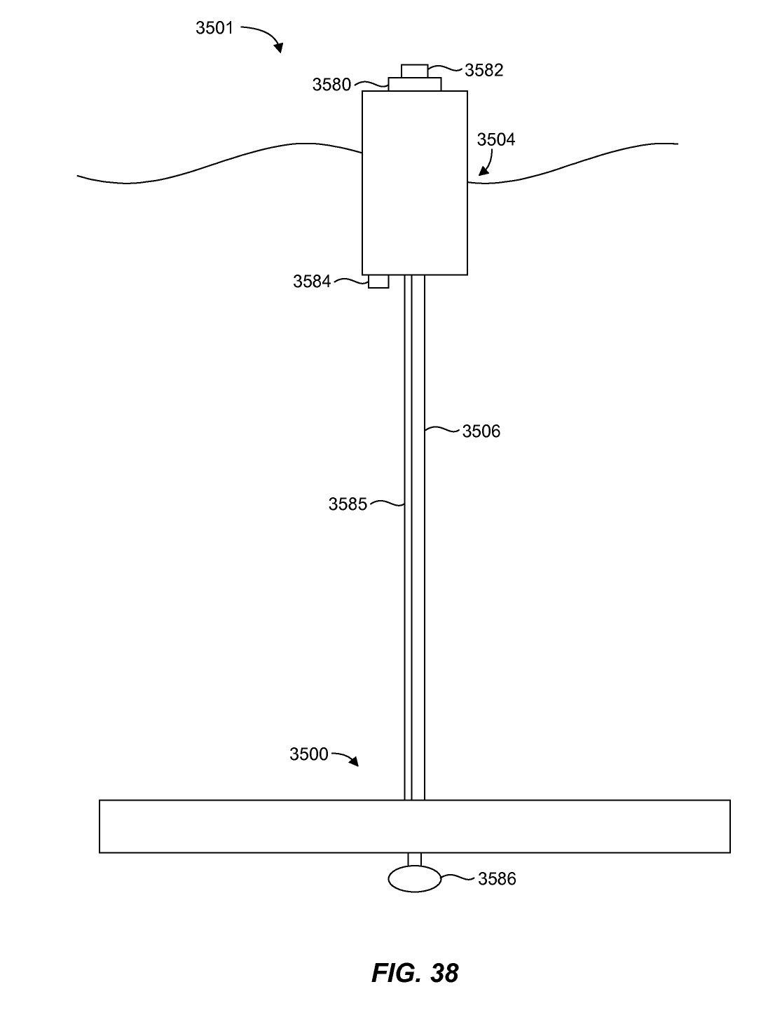

FIG. 39 is an illustration of an underwater utility system 3601 in accordance with another example of the present disclosure. The system 3601 can include an underwater utility line 3600, which may or may not be adjustably buoyant, and one or more buoys 3604 coupled to the underwater utility line 3600, such as via tethers 3606, which can comprise a cable, a chain, and/or a rod. The buoys 3604 can also include a computer 3680, a global position system receiver 3682, and/or a sonar unit 3684. In addition, the system 3601 can include a drive device 3688 operable with the tether 3606 to raise and lower the underwater utility line 3600 for any suitable purpose, such as the purposes mentioned above. The drive device 3688 can include a gear, a pulley, or any other suitable mechanism to interface with the tether 3606 and cause movement of the underwater utility line 3600 along the tether. A motor of the drive device can receive power from an electrical line of the underwater utility line 3600. In one aspect, a controller of the underwater utility line 3600 can be used to control the drive mechanism 3688, such that the drive mechanisms associated with the various buoy tethers 3606 can operate in a coordinated manner.

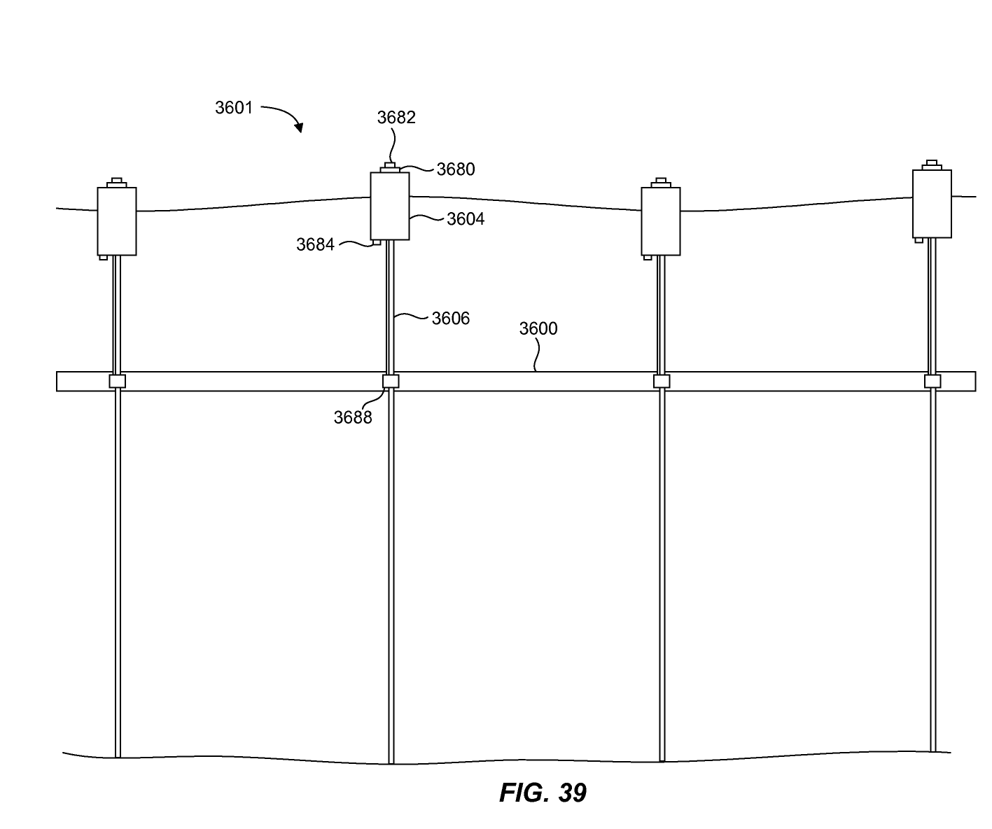

FIG. 40 is an illustration of an underwater utility system 3700 in accordance with yet another example of the present disclosure. The system 3701 can include an underwater utility line 3700, which may or may not be adjustably buoyant, and one or more buoys 3704, such as those described herein, coupled to the underwater utility line 3700 via tethers 3706. The tethers 3706 can comprise a helical configuration to allow the buoys 3704 to have unrestricted vertical movement upon waves in a body of water. In one aspect, the underwater utility line 3700 can be configured to reside on an ocean floor 3708. In another aspect, the underwater utility line 3700 can be adjustably buoyant, as described hereinabove. Thus, the helical configuration of the tethers 3706 can accommodate vertical movement of the underwater utility line 3700 as buoyancy is adjusted to raise and lower the underwater utility line. The buoys 3704 can serve to mark a location of the underwater utility line 3700 and/or be used to generate power from wave energy.

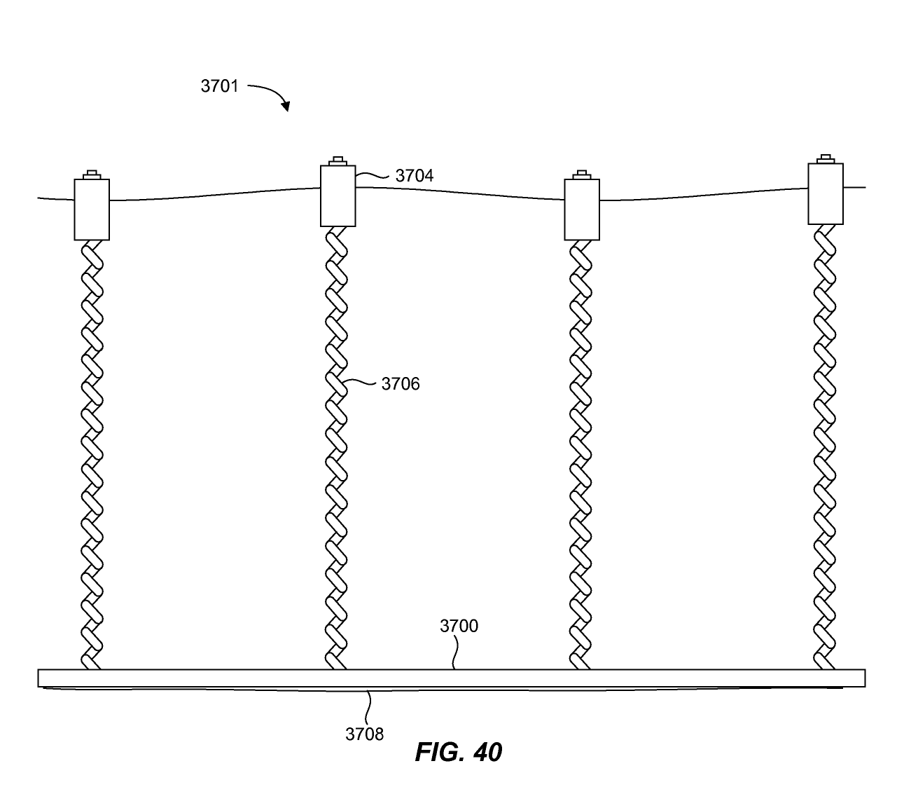

For example, FIG. 41 illustrates an underwater utility system 3801 in accordance with still another example of the present disclosure, in which buoys 3804 are used to generate power from wave energy. The buoys 3804 can be associated with power generators, such as pumps, and can be coupled to an underwater utility line 3800 via tethers 3806, which can serve as feed lines to deliver power from the power generators to a transmission line of the underwater utility line. For example, the buoys 3804 can be configured to pump water and pressurized water can be conveyed through the tethers 3806, which can be tubular, to the underwater utility line 3800 for transfer to another location. The tethers or feed lines 3806 can be resiliently flexible to allow the buoys 3804 to have unrestricted movement to generate power. In one aspect, the tethers or feed lines 3806 can comprise a helical configuration. The helical configuration can facilitate flexibility of the tubular tethers or feed lines 3806 even when pressurized. The underwater utility line 3800 may or may not be adjustably buoyant. The tethers or feed lines 3806 can have some degree of buoyancy, which can be configured, as desired, such as to reduce or minimize a load on the buoys 3804.

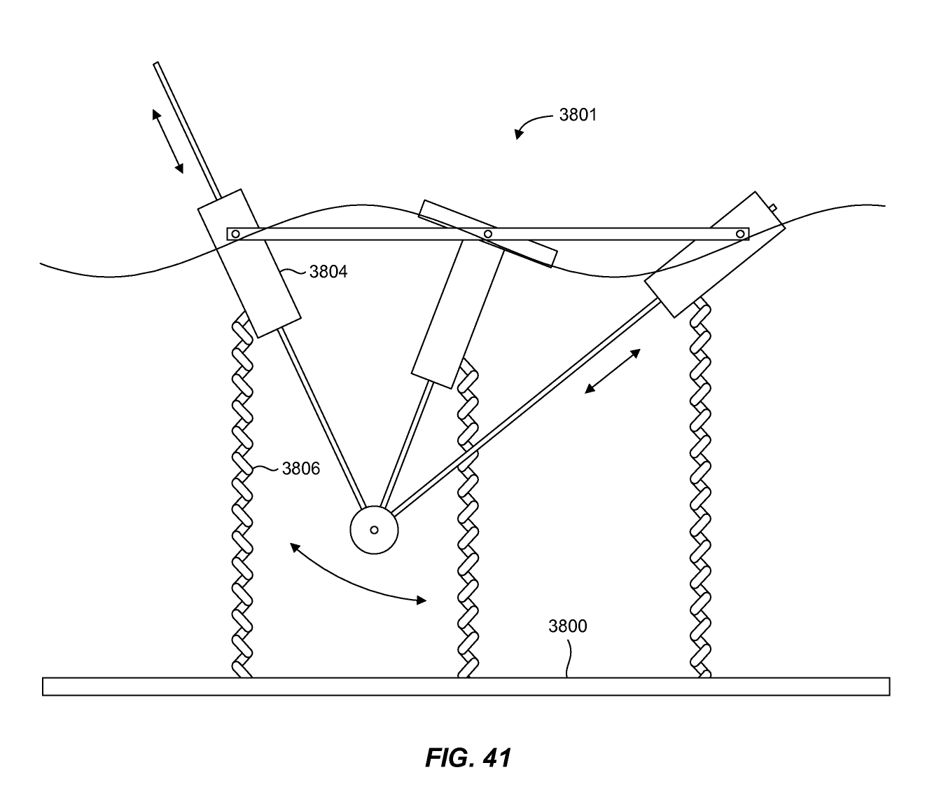

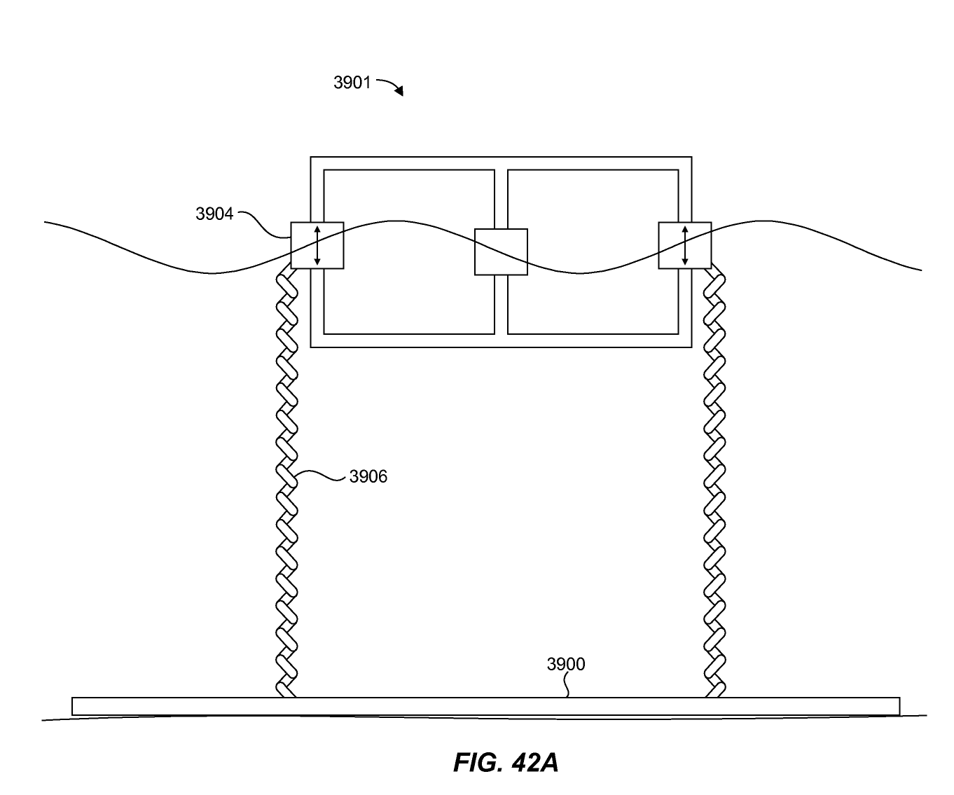

FIG. 42A is an illustration of an underwater utility system 3901 in accordance with a further example of the present disclosure, in which buoys 3904 are used to generate power from wave energy. The buoys 3904 can be associated with power generators and can be coupled to an underwater utility line 3900 via tethers 3906, which can serve as feed lines to deliver power from the power generators to a transmission line of the underwater utility line. As described above, the tethers or feed lines 3906 can be resiliently flexible and can have a helical configuration.

In a similar embodiment, FIG. 42B illustrates an underwater utility system 4001 having the same basic structure as found in the underwater utility system 3901 of FIG. 42A. In this case, the underwater utility system 4001 includes an extension member 4090 extending downward from a frame 4091. The extension member 4090 can extend from a middle portion of the frame 4091, such as below a fixed buoy 4092. The extension member 4090 can be made heavy enough such that no rocking motion is allowed or light enough such that a little rocking motion is allowed but with positive stability.

Buoys 4004a, b can be associated with power generators and can be coupled to an underwater utility line 4000 via tethers or feed lines 4006a, b, which can combine to form a common tether or feed line 4006c that extends to the utility line. In one aspect, the tethers or feed lines 4006a, b can combine at, and/or be coupled to, the extension member 4090. Thus, the extension member 4090 can support the tether or utility lines 4006a, b so that movement of the movable buoys 4004a, b is not hindered. Such tethers or feed lines can serve to deliver power from the power generators to a transmission line of the underwater utility line 4000. As described above, the tethers or feed lines 4006a-c can be resiliently flexible and can have a helical configuration, such as when delivering pressurized water, or the tethers or feed lines can simply comprise an electrically conductive cable if transferring electricity.

Such underwater utility systems 3801, 3901, 4001 as illustrated in FIGS. 41, 42A, and 42B, respectively, can be dragged behind a ship and used to provide supplemental power to the ship. In this case, a tow line may be used to couple with a frame associated with the buoys to tow the underwater utility system and protect the underwater utility line from being subjected to tensile forces that may damage the utility line. When towing such underwater utility systems, power generation by induction may be preferred due to the wave motion characteristics of towing the system behind a ship.

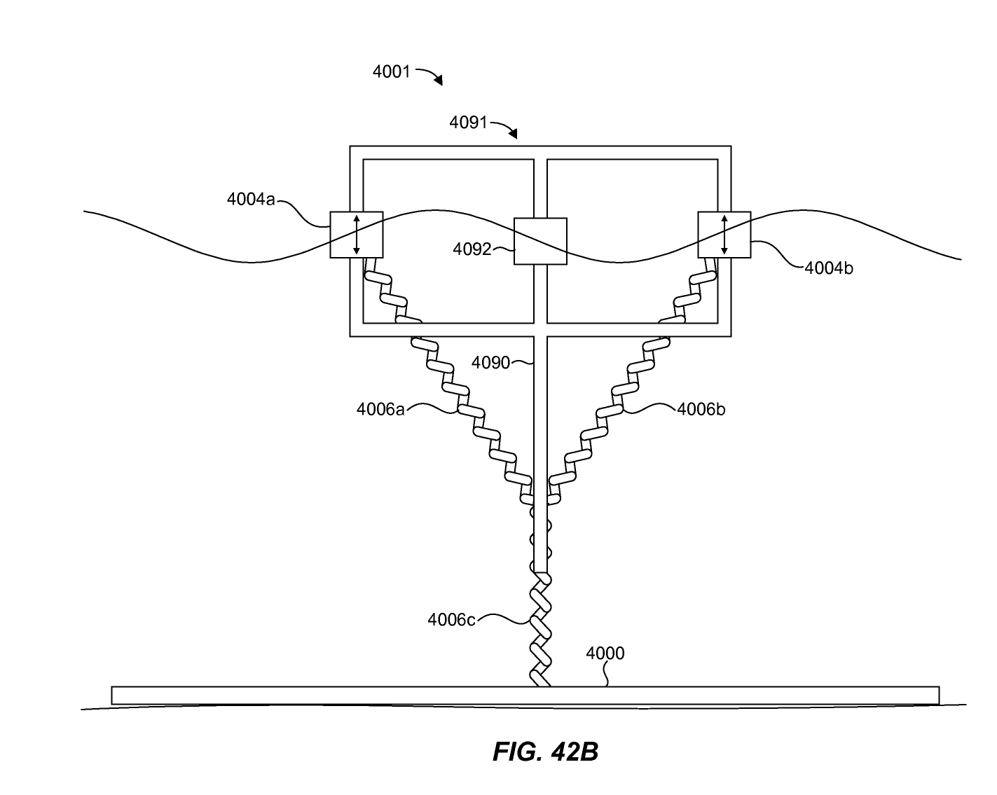

FIG. 43 is a side view of a tether or feed line 4106 of an underwater utility system in accordance with an example of the present disclosure. The tether or feed line 4106 can comprise a helical configuration and can include a support structure 4107 to maintain the helical configuration during use. In one aspect, the support structure 4107 can comprise an outer sheath to provide external support to the tether or feed line 4106. The outer sheath may or may not be permanently attached to the tether or feed line 4106.

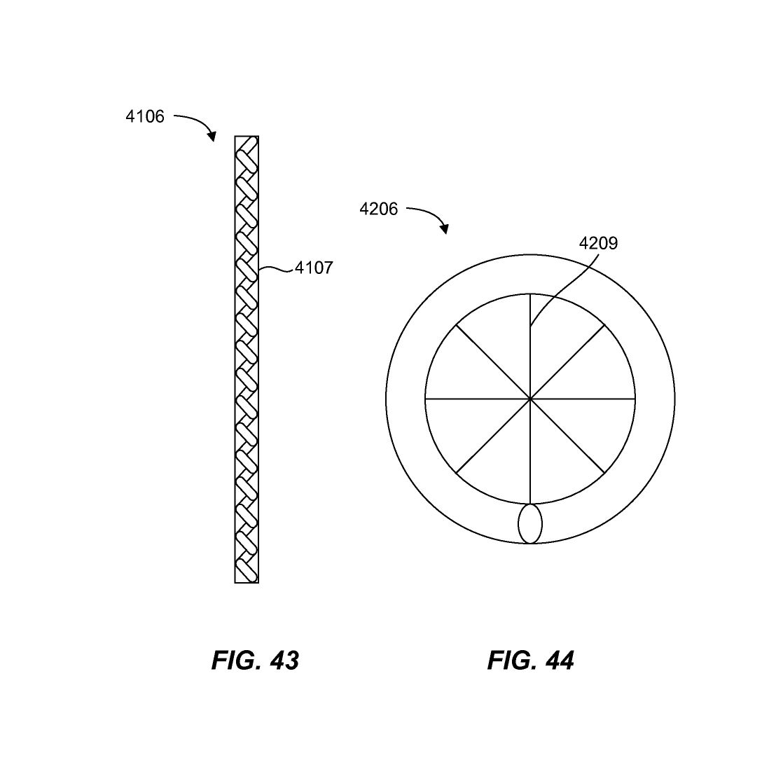

FIG. 44 is a top view of a tether or feed line 4206 of an underwater utility system in accordance with another example of the present disclosure. The tether or feed line 4206 can comprise a helical configuration and can include a support structure 4207 to maintain the helical configuration during use. In this case, the support structure 4207 can comprise an inner webbing attached to an interior portion of the helical tether or feed line 4206 to provide internal support to the tether or feed line.

In accordance with one embodiment of the present disclosure, a method for transferring energy through a body of water is disclosed. The method can include connecting an underwater utility line to an energy source and an energy destination, the underwater utility line having an adjustably buoyant tube, and a transmission line to transfer energy disposed in an interior of the adjustably buoyant tube. The method can also include providing gas to the adjustably buoyant tube. In addition, the method can include controlling the gas provided by the gas source to alter the buoyancy of the adjustably buoyant tube. In one aspect, the method can further comprise expanding or contracting the adjustably buoyant tube with the gas to alter the buoyancy of the adjustably buoyant tube. It is noted that no specific order is required in this method, though generally in one embodiment, these method steps can be carried out sequentially.

It is to be understood that the embodiments of the disclosure disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present disclosure. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present disclosure may be referred to herein along with alternatives for the various components thereof. It is understood that such embodiments, examples, and alternatives are not to be construed as de facto equivalents of one another, but are to be considered as separate and autonomous representations of the present disclosure.

Furthermore, the described features, structures, or characteristics may be combined in any suitable manner in one or more embodiments. In the description, numerous specific details are provided, such as examples of lengths, widths, shapes, etc., to provide a thorough understanding of embodiments of the disclosure. One skilled in the relevant art will recognize, however, that the technology can be practiced without one or more of the specific details, or with other methods, components, materials, etc. In other instances, well-known structures, materials, or operations are not shown or described in detail to avoid obscuring aspects of the disclosure.

While the foregoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the disclosure. Accordingly, it is not intended that the disclosure be limited, except as by the claims set forth below.

What is claimed is:

1. A buoy for obtaining energy from a wave in a body of water, comprising:
a floatation portion to provide buoyancy for the buoy in water;
a ballast portion operable with the floatation portion to move in a pendulum motion in response to a wave in the body of water, wherein the floatation portion is substantially maintained above the ballast portion; and
an energy conversion device to generate power in response to the pendulum motion of the ballast portion.

2. The buoy of claim 1, wherein the floatation portion is configured to maintain the buoy substantially in the water.

3. The buoy of claim 1, wherein the floatation portion is configured to facilitate the pendulum motion of the ballast portion.

4. The buoy of claim 3, wherein the floatation portion is configured to follow a surface of the wave to facilitate the pendulum motion of the ballast portion.

5. The buoy of claim 3, wherein the floatation portion comprises a lower floatation portion and an upper floatation portion, and wherein a diameter of the upper floatation portion is greater than a diameter of the lower floatation portion to facilitate the pendulum motion of the ballast portion.

6. The buoy of claim 1, wherein the ballast portion is proximate the floatation portion.

7. The buoy of claim 1, wherein the ballast portion is suspended below the floatation portion.

8. The buoy of claim 7, further comprising an extension member coupled to the floatation portion and the ballast portion to suspend the ballast portion below the floatation portion.

9. The buoy of claim 1, wherein the ballast portion comprises the energy conversion device.

10. The buoy of claim 1, wherein the energy conversion device is coupled to the ballast portion.

11. The buoy of claim 10, further comprising a connecting member coupled to the ballast portion and the energy conversion device to couple the energy conversion device to the ballast portion.

12. The buoy of claim 11, wherein the connecting member is movable relative to the energy conversion device to facilitate power generation.

13. The buoy of claim 11, further comprising a framework coupled to the floatation portion to support the energy conversion device.

14. The buoy of claim 13, further comprising a second floatation portion associated with the energy conversion device to support the energy conversion device.

15. The buoy of claim 1, wherein the energy conversion device generates electricity.

16. The buoy of claim 15, wherein the energy conversion device generates electricity via electromagnetic induction.

17. The buoy of claim 15, wherein the energy conversion device comprises:
a support member defining a first side and a second side;
a permanent magnet supported by the support member;
a first stator assembly disposed about the first side of the support member; and
a second stator assembly disposed about the second side of the support member, wherein relative movement of the permanent magnet and the first and second stator assemblies generates electricity via electromagnetic induction.

18. The buoy of claim 17, wherein the relative movement of the permanent magnet and the inner and outer stator assemblies is rotational.

19. The buoy of claim 17, wherein the relative movement of the permanent magnet and the inner and outer stator assemblies is translational.

20. The buoy of claim 17, wherein the support member is movably supported by a magnetic bearing.

21. The buoy of claim 17, wherein the support member comprises a cylindrical configuration.

22. The buoy of claim 17, wherein the first side comprises an exterior of the support member and the second side comprises an interior of the support member.

23. The buoy of claim 17, wherein the support member is rigid.

24. The buoy of claim 17, wherein the support member is flexible.

25. The buoy of claim 24, wherein the support member comprises a belt configuration.

26. The buoy of claim 24, wherein the support member is routed about at least two sides of at least one of the first and second stator assemblies.

27. The buoy of claim 17, wherein the permanent magnet comprises a plurality of permanent magnets configured to extend from the first side of the support member about at least two sides of the first stator assembly.

28. The buoy of claim 27, wherein the plurality of permanent magnets is configured to extend from the second side of the support member about at least two sides of the second stator assembly.

29. The buoy of claim 27, wherein the permanent magnet comprises a second plurality of permanent magnets configured to extend from the second side of the support member about at least two sides of the second stator assembly.

30. The buoy of claim 27, wherein the support member is rigid.

31. The buoy of claim 27, wherein the support member is flexible.

32. The buoy of claim 1, wherein the energy conversion device comprises a turbine generator.

33. The buoy of claim 1, wherein the energy conversion device comprises a pump.

34. A method for obtaining energy from a wave in a body of water, comprising:
obtaining a buoy having:
a floatation portion to provide buoyancy for the buoy in water,
a ballast portion operable with the floatation portion to move in a pendulum motion in response to a wave in the body of water, wherein the floatation portion is substantially maintained above the ballast portion, and
an energy conversion device to generate power in response to the pendulum motion of the ballast portion; and
disposing the buoy in the body of water.

35. The method of claim 34, wherein the floatation portion is configured to follow a surface of the wave to facilitate the pendulum motion of the ballast portion.

36. A buoy for obtaining energy from a wave in a body of water, comprising:
first and second floatation portions to provide buoyancy in water; and
an energy conversion device associated with the first and second floatation portions, the energy conversion device including
a frame defining a first side and a second side,
a permanent magnet supported by the frame,
a first stator assembly disposed about the first side of the frame and coupled to the first floatation portion, and
a second stator assembly disposed about the second side of the frame and coupled to the second floatation portion,
wherein the first and second floatation portions are moveable relative to the frame such that a wave in a body of water causes relative movement of the first and second stator assemblies and the permanent magnet to generate electricity via electromagnetic induction.

37. The buoy of claim 36, wherein the first and second floatation portions are translatable relative to the frame.

38. The buoy of claim 36, further comprising a magnetic bearing to facilitate relative movement of the first and second floatation portions and the frame.

39. The buoy of claim 36, wherein the frame comprises a cylindrical configuration.

40. The buoy of claim 36, wherein the frame comprises a planar configuration.

41. The buoy of claim 36, wherein the first side comprises an exterior of the frame and the second side comprises an interior of the frame.
